(19) United States
(12) Patent Application Publication
(10) Pub. No.: US 2024/0085351 A1
(43) Pub. Date: Mar. 14, 2024

(54) DEPTH-PROFILING OF SAMPLES BASED ON X-RAY MEASUREMENTS

(71) Applicant: APPLIED MATERIALS ISRAEL LTD., Rehovot (IL)

(72) Inventors: Doron Girmonsky, Raanana (IL); Michal Eilon, Beit-Elazari (IL); Dror Shemesh, Hod Hasharon (IL); Uri Hadar, Tel-Aviv (IL)

(73) Assignee: APPLIED MATERIALS ISRAEL LTD., Rehovot (IL)

(21) Appl. No.: 18/231,567

(22) Filed: Aug. 8, 2023

Related U.S. Application Data
(63) Continuation-in-part of application No. 17/901,705, filed on Sep. 1, 2022.

(51) Int. Cl. G01N 23/083; G06T 7/00

(52) U.S. Cl. CPC G01N 23/083; G06T 7/001; G06T 2207/10116; G06T 2207/20084

(57) ABSTRACT

Disclosed herein is a system for non-destructive depth-profiling of samples. The system includes an electron beam source, a light sensor, and processing circuitry. The electron beam source configured to project e-beams on an inspected sample at each of a plurality of landing energies, which induce X-ray emitting interactions within each of a plurality of probed regions in the inspected sample, respectively, whose depth is determined by the landing energy. The light sensor is configured to measure the emitted X-ray light to obtain optical emission data sets pertaining to each of the probed regions, respectively. The processing circuitry is configured to determine a set of structural parameters, characterizing an internal geometry and/or a composition of the inspected sample, based on the measured optical emission data sets and taking into account reference data indicative of an intended design of the inspected sample.

### CROSS-REFERENCES TO RELATED APPLICATIONS

This application is a continuation-in-part of U.S. patent application Ser. No. 17/901,705, filed Sep. 1, 2022, the contents of which are hereby incorporated by reference in its entirety.

### TECHNICAL FIELD

The present disclosure relates generally to depth-profiling of structures based on X-ray measurements.

### BACKGROUND OF THE INVENTION

Currently, more than forty different materials are employed in the semiconductor industry. Accordingly, material characterization—specifically, in the logic and memory segments, material depth-profiling—plays an ever more crucial role. For example, concentration mapping of nitrogen and fluorine in a gate stack is critical for ensuring device performance and reliability. State-of-the-art techniques for material z-profiling include time-of-flight secondary ion mass spectrometry (ToF-SIMS) and transmission electron microscopy energy dispersive X-ray (TEM-EDX) spectroscopy. However, both techniques are destructive. There is a need in the art for non-destructive material z-profiling techniques.

### BRIEF SUMMARY OF THE INVENTION

Aspects of the disclosure, according to some embodiments thereof, relate to depth-profiling of structures based on X-ray measurements. More specifically, but not exclusively, aspects of the disclosure, according to some embodiments thereof, relate to depth-profiling (or z-profiling) of materials, such as fluorine and/or nitrogen, introduced into semiconductor structures to tweak one or more physical properties thereof.

Thus, according to an aspect of some embodiments, there is provided a computer-based method for non-destructive depth-profiling of samples. The method includes:
A measurement operation including—for each of a (first) plurality of landing energies (i.e. landing energies of e-beams, also referable to as “e-beam landing energies”), selected so as to allow probing an inspected sample to a plurality of depths—suboperations of:
   Projecting an electron beam (e-beam) on the inspected sample. The e-beam penetrates the sample and induces light-emitting interactions (e.g. X-ray light-emitting interactions) within a respective probed region of the inspected sample, whose depth is determined by the landing energy.
   Measuring the emitted light to obtain an optical emission data set pertaining to the probed region.
A data analysis operation a set of structural parameters, which characterizes an internal geometry and/or a composition of the inspected sample, is determined based on the measured optical emission data sets and taking into account reference data indicative of an intended design of the inspected sample.

According to some embodiments of the depth-profiling method, the reference data include design data of the inspected sample and/or ground truth (GT) data of other samples of the same intended design as the inspected sample and/or GT data of especially prepared samples exhibiting selected variations, respectively, relative to the intended design.

According to some embodiments of the depth-profiling method, the set of structural parameters specifies a concentration map quantifying a dependence of a concentration of a target material, which the inspected sample includes, at least on the depth.

According to some embodiments of the depth-profiling method, the sample includes a bulk into which the target material has been introduced. The intended design of the sample specifies an intended design of the bulk. According to some such embodiments, the intended design of the sample further specifies a nominal density distribution of the target material.

According to some embodiments of the depth-profiling method, the bulk is or includes a semiconductor structure.

According to some embodiments of the depth-profiling method, the target material includes fluorine, nitrogen, boron, and/or gallium.

According to some embodiments of the depth-profiling method, the set of structural parameters includes one or more of:
one or more overall concentrations of one or more materials that the inspected sample includes; and
at least one width of at least one structure, respectively, which is embedded in the inspected sample; and
   when the inspected sample includes a plurality of layers:
at least one thickness of at least one of the plurality of layers, respectively;
a combined thickness of at least some of the plurality of layers; and
at least one mass density of at least one of the plurality of layers, respectively.

According to some embodiments of the depth-profiling method, the landing energies are selected so as to induce emission of X-rays from each of the probed regions. The X-rays constitute at least part of the emitted light. According to some such embodiments, the landing energies are selected so as to induce emission of characteristic X-rays from each of the probed regions.

According to some embodiments of the depth-profiling method, for each landing energy the characteristic X-ray (X-ray light) emitting interactions are substantially limited to the respective probed region.

According to some embodiments of the depth-profiling method, each of the suboperations of measuring the emitted light includes measuring characteristic X-rays corresponding to the target material.

According to some embodiments of the depth-profiling method, each of the suboperations of measuring the emitted light includes measuring an intensity of at least a portion of the respectively emitted light. The measured portion has a frequency equal to, or within a frequency range about, a peak characteristic X-ray emission frequency of the target material. According to some such embodiments, the peak is the tallest peak.

According to some embodiments of the depth-profiling method, the measurement operation is performed with respect to each of a plurality of lateral (i.e. horizontal) locations on the sample at which the respective plurality of e-beams is projected. According to some such embodiments, the set of structural parameters specifies a three-dimensional concentration map.

According to some embodiments of the depth-profiling method, the measuring of the emitted light includes, for each of a plurality of return angles (collection angles), measuring a respective number of photons returned at the return angle.

According to some embodiments of the depth-profiling method, each of the suboperations of measuring the emitted light includes using an image sensor obtain a two-dimensional image of the respectively emitted light. Each of the obtained two-dimensional images constitutes or is included in the respective optical emission data set.

According to some embodiments of the depth-profiling method, the sample includes a plurality of layers each including one or more respective semiconductor materials.

According to some embodiments of the depth-profiling method, the depth of the probed region increases with the landing energy.

According to some embodiments of the depth-profiling method, the concentration map is a mass density distribution or a particle density distribution.

According to some embodiments of the depth-profiling method, within each of the probed regions a respective relative concentration of the target material is at most about 5%.

According to some embodiments of the depth-profiling method, the data analysis operation includes, as part of determining the set of structural parameters, executing a trained algorithm (an algorithm derived using machine-learning (ML) tools, also referred to as “ML-derived algorithm”), which is configured to receive as inputs the optical emission data sets, or key optical emission parameters, extracted from the optical emission data sets, and output the set of structural parameters. According to some such embodiments, each of the optical emission data sets, or the key optical emission parameters, is labelled by the landing energy (from the first plurality of landing energies) of the respectively inducing e-beam.

According to some embodiments of the depth-profiling method, weights of the trained algorithm are determined through training using the reference data and (i) key optical emissions parameters, which are derived (extracted) from optical emission data sets of other samples of the same intended design as the inspected sample, and/or (ii) simulation data, which are derived from simulating an application of the measurement operation with respect to samples of the same intended design as the inspected sample with e-beams at each of a second plurality of landing energies, which differs from the first plurality of landing energies.

According to some embodiments of the depth-profiling method, the trained algorithm is or includes a trained neural network (NN) or a trained linear model-incorporating algorithm.

According to some embodiments of the depth-profiling method, wherein the measurement operation is performed with respect to each of a plurality of lateral locations on the sample at which the respective plurality of e-beam is projected, each of the obtained optical emission data sets, or the key optical emission parameters, which are input into the trained algorithm, are further labelled by the lateral coordinates of the respective lateral location at which the respective e-beam impinged the inspected sample.

According to some embodiments of the depth-profiling method, the NN is a regression NN.

According to some embodiments of the depth-profiling method, wherein the set of structural parameters specifies a concentration map, the NN is a classification NN and at each map coordinate(s) the concentration map specifies the density of the target material to within a respective density range from a plurality of density ranges.

According to some embodiments of the depth-profiling method, the trained algorithm includes a variational autoencoder (VAE) and a classifier.

According to some embodiments of the depth-profiling method, the NN is a deep NN or a generative adversarial network (GAN).

According to some embodiments of the depth-profiling method, the deep NN is a convolutional NN or a fully connected NN.

According to some embodiments of the depth-profiling method, the inspected sample is a semiconductor specimen.

According to some embodiments of the depth-profiling method, the inspected sample is a patterned wafer.

According to an aspect of some embodiments, there is provided a method for training an algorithm (e.g. a neural network) for use in non-destructive depth-profiling of samples. The training method includes operations of:
Generating simulated training data for an algorithm. The algorithm is configured to (i) receive as inputs, optical emission data sets of a sample, and/or key optical emission parameters of the sample, each pertaining to a respective landing energy from a plurality of landing energies of a respectively inducing electron beam (e-beam), and (ii) output a set of structural parameters characterizing an internal geometry and/or a composition of the sample. The training data is generated by suboperations of:
   For each of a plurality of ground truth (GT) samples, generating calibration data by:
      Obtaining measured optical emission data sets of the GT sample by projecting thereon e-beams (e.g. one at a time) at each of a first plurality of landing energies and measuring light returned from the GT sample.
      Obtaining GT data characterizing the GT sample.
   Using the calibration data to calibrate a computer simulation. The computer simulation is configured to (a) receive as inputs GT data characterizing a sample and landing energies, and (b) output corresponding simulated optical emission data sets and/or simulated key optical emission parameters.
   Using the calibrated computer simulation to generate additional simulated optical emission data sets, and/or simulated key optical emission parameters, corresponding to other GTs and/or additional landing energies (beyond the first plurality of landing energies).
Training the algorithm using at least the simulated training data.

According to some embodiments of the training method, at least some of the GT samples are of the same intended design as the inspected sample and/or at least some of the GT samples are especially prepared to exhibit selected variations, respectively, with respect to the intended design.

According to some embodiments of the training method, the measured GT data specify concentration maps of one or more materials, which each of the GT samples nominally include.

According to some embodiments of the training method, the set of structural parameters specifies a concentration map of a target material from the one or more materials.

According to some embodiments of the training method, the set of structural parameters includes one or more of:
overall concentrations of one or more materials, respectively, that the GT samples nominally include; and
at least one width of at least one structure, respectively, that the GT samples nominally include; and
   when each of the GT samples nominally includes a plurality of layers:
at least one thickness of at least one of the plurality of layers, respectively;
a combined thickness of at least some of the plurality of layers; and
at least one mass density of at least one of the plurality of layers, respectively.

According to some embodiments of the training method, the algorithm is or includes a (trained) neural network (NN).

According to some embodiments of the training method, the algorithm is configured to receive as inputs key optical emission parameters and the computer simulation is configured to output simulated key optical emission parameters. The method includes an additional suboperation, which is implemented prior to the suboperation of using the calibration data, wherein key optical emission parameters are extracted from the measured optical emission data sets.

According to some embodiments of the training method, the computer simulation is calibrated such that for each pair of (i) measured GT data obtained in the suboperation of generating the calibration data, and (ii) a landing energy utilized in the suboperation of generating the calibration data, which (i.e. the pair) is input into the computer simulation, simulated key optical emission parameters, which are output by the computer simulation, agree to within a required precision with the key optical emission parameters extracted from the respective measured optical emission data set.

According to some embodiments of the training method, prior to the calibration thereof, the computer simulation specifies initial point spread functions (PSFs) at least for each of the first plurality of landing energies. In the suboperation of calibrating the computer simulation, the initial PSFs are calibrated, thereby obtaining calibrated PSFs.

According to some embodiments of the training method, each of the initial PSFs is piecewise linearized as a function of a density of a target material, which the GT samples nominally include.

According to some embodiments of the training method, a modified Richardson-Lucy algorithm is applied to obtain the calibrated PSFs from the initial PSFs.

According to some embodiments of the training method, an adjustable U-Net deep learning NN is applied to obtain the calibrated PSFs from the initial PSFs, and optimized over adjustable parameters thereof.

According to some embodiments of the training method, the other GTs correspond to additional samples are of different intended designs than the plurality of GT samples.

According to some embodiments of the training method, the training method further includes reapplying the operation of generating simulated training data and the operation of training the algorithm, when additional calibration data are available.

According to some embodiments of the training method, the NN is a regression NN.

According to some embodiments of the training method, the NN is a classification NN. According to some such embodiments, the set of structural parameters, output by the classification NN, specifies a concentration map of a target material, such that at each map coordinate(s), a density of the target material is specified to within a respective density range from a plurality of density ranges.

According to some embodiments of the training method, the NN is a deep NN or a GAN.

According to some embodiments of the training method, the deep NN is a convolutional NN or a fully connected NN.

According to some embodiments of the training method, a ratio of a number of the additional simulated optical emission data sets to a number of the measured optical emission data sets is between about 100 and about 1,000.

According to some embodiments of the training method, the measured GT data are obtained by profiling lamellas extracted from each of the plurality GT samples and/or slices shaved thereof. According to some such embodiments, the profiling is performed using transmission electron microscopy and/or scanning electron microscopy.

According to some embodiments of the training method, the light measured in the suboperation of obtaining the measured optical emission data sets is X-ray light (i.e. X-ray radiation).

According to some embodiments of the training method, the samples are semiconductor specimens.

According to some embodiments of the training method, the samples are patterned wafers.

According to some embodiments of the training method, the suboperation of obtaining measured optical emission data sets of the sample includes measuring the light returned from the sample at each of two or more return angles (i.e. collection angles), respectively.

According to an aspect of some embodiments, there is provided a system for non-destructive depth-profiling of samples. The system includes an e-beam source, a light sensor, and processing circuitry (also referable to as “computational module”). The e-beam source is configured to project e-beams on an inspected sample at each of a (first) plurality of landing energies: Each e-beam (penetrates into the sample and) induces light-emitting interactions within a respective probed region of the inspected sample, whose depth (i.e. the depth of the probed region) is determined by the landing energy. The plurality of landing energies is selected so as to allow probing the inspected sample to a plurality of depths. The light sensor is configured to measure the emitted light to obtain optical emission data sets pertaining to the probed regions, respectively. The processing circuitry is configured to determine a set of structural parameters, which characterize an internal geometry and/or a composition of the inspected sample, based on the measured optical emission data sets and taking into account reference data indicative of an intended design of the inspected sample.

According to some embodiments of the system, the reference data include design data of the inspected sample and/or ground truth (GT) data of other samples of the same intended design as the inspected sample and/or GT data of especially prepared samples exhibiting selected variations, respectively, relative to the intended design.

According to some embodiments of the system, the set of structural parameters specifies a concentration map quantifying a dependence of a concentration of a target material, which the inspected sample includes, at least on the depth.

According to some embodiments of the system, the sample includes a bulk into which the target material has been introduced. The intended design of the sample specifies an intended design of the bulk. According to some such embodiments, the intended design of the sample further specifies a nominal density distribution of the target material.

According to some embodiments of the system, the bulk is or includes a semiconductor structure.

According to some embodiments of the system, the target material includes fluorine, nitrogen, boron, and/or gallium.

According to some embodiments of the system, the set of structural parameters includes one or more of:
an overall concentration of at least one material that the inspected sample includes; and
at least one width of at least one structure, respectively, which is embedded in the inspected sample; and
   when the inspected sample includes a plurality of layers:
at least one thickness of at least one of the plurality of layers, respectively;
a combined thickness of at least some of the plurality of layers; and
at least one mass density of at least one of the plurality of layers, respectively.

According to some embodiments of the system, the landing energies are such that emission of X-rays from the probed regions is induced. The X-rays constitute at least part of the emitted light. According to some such embodiments, the landing energies are such that emission of characteristic X-rays from each of the probed regions is induced.

According to some embodiments of the system, for each landing energy the characteristic X-ray emitting interactions are substantially limited to the respective probed region.

According to some embodiments of the system, the light sensor is configured to sense characteristic X-rays corresponding to the target material.

According to some embodiments of the system, the light sensor is configured to measure an intensity of a portion the respectively emitted light, which has a frequency equal to, or within a frequency range about, a peak characteristic X-ray emission frequency of the target material. According to some such embodiments, the peak is the tallest peak.

According to some embodiments of the system, the light sensor includes an energy-dispersive X-ray spectrometer or a wavelength-dispersive X-ray spectrometer.

According to some embodiments of the system, the system is further configured to allow projecting the e-beams so as to impinge on the sample at each of controllably selectable lateral locations thereon. According to some such embodiments, the set of structural parameters specifies a three-dimensional concentration map.

According to some embodiments of the system, the light sensor may be configured to measure the number photons returned at each of two or more returned angles, respectively. According to some such embodiments, the light sensor may include two or more light sensors (e.g. one or more energy-dispersive X-ray spectrometers and/or one or more wavelength-dispersive X-ray spectrometers).

According to some embodiments of the system, the light sensor includes an image sensor configured to obtain two-dimensional images of the emitted light. The two-dimensional images constitute at least part of the optical emission data sets.

According to some embodiments of the system, for each landing energy, the respective light emitting interactions between electrons from the e-beam and the sample are substantially limited to the probed region.

According to some embodiments of the system, the depth of the probed region increases with the landing energy.

According to some embodiments of the system, the concentration map is a mass density distribution or a particle density distribution.

According to some embodiments of the system, within each of the probed regions a respective relative concentration of the target material is at most about 5%.

According to some embodiments of the system, in order to determine the set of structural parameters, the processing circuitry is configured to execute a trained algorithm (an algorithm derived using machine-learning (ML) tools, also referred to as “ML-derived algorithm”), which is configured to receive as inputs the optical emission data sets, or key optical emission parameters extracted from the optical emission data sets, and output the set of structural parameters. According to some such embodiments, each of the optical emission data sets, or the key optical emission parameters, the is labelled by the landing energy (from the first plurality of landing energies) of the respectively inducing e-beam.

According to some embodiments of the system, weights of the trained algorithm are determined through training using the reference data and (i) key optical emissions parameters, which are derived (extracted) from optical emission data sets of other samples of the same intended design as the inspected sample, and/or (ii) simulation data, which are derived from simulating an application of the measurement operation with respect to samples of the same intended design as the inspected sample with e-beams at each of a second plurality of landing energies, which differs from the first plurality of landing energies.

According to some embodiments of the system, the trained algorithm is or includes a trained neural network (NN), or a trained linear model-incorporating algorithm.

According to some embodiments of the system, wherein the system is further configured to allow projecting the e-beams so as to impinge on the inspected sample at each of controllably selectable lateral locations thereon, each of the obtained optical emission data sets, or the key optical emission parameters, which are input into the trained algorithm, are further labelled by the lateral coordinates of the respective lateral location at which the respective e-beam impinged the inspected sample.

According to some embodiments of the system, the NN is a regression NN.

According to some embodiments of the system, the NN is a classification NN. According to some such embodiments, wherein the set of structural parameters specifies a concentration map, at each map coordinate(s) the concentration map specifies the density of the target material to within a respective density range from a plurality of density ranges.

According to some embodiments of the system, the trained algorithm includes a VAE and a classifier.

According to some embodiments of the system, the NN is a deep NN or a GAN.

According to some embodiments of the system, the deep NN is a convolutional NN or a fully connected NN.

According to some embodiments of the system, the sample is semiconductor specimen.

According to some embodiments of the system, the sample is a patterned wafer.

According to an aspect of some embodiments, there is provided a non-transitory computer-readable storage medium storing instructions that cause a system for non-destructive depth-profiling of samples (such as the above-described system) to implement the above-described depth-profiling method.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, flash memories, solid state drives (SSDs), or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE DRAWINGS

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1 presents a flowchart of a method for depth-profiling of samples, according to some embodiments;

FIG. 2A-2D schematically depict a sample undergoing depth-profiling in accordance with the method of FIG. 1, according to some embodiments;

FIG. 3A presents an X-ray emission spectrum of an inspected sample, which was obtained by implementing a measurement operation of the method of FIG. 1, according to some embodiments thereof;

FIG. 3B presents an optimized curve which was fitted onto the X-ray emission spectrum of FIG. 3A, in accordance with specific embodiments of a measurement data analysis operation of the method of FIG. 1;

FIG. 3C presents the optimized curve of FIG. 3B superimposed on the X-ray emission spectrum of FIG. 3A;

FIG. 3D presents a fitted gaussian included in the optimized curve of FIG. 3B, according to some embodiments;

FIG. 3E presents a fitted polynomial included in the optimized curve of FIG. 3B, the fitted polynomial accounting for bremsstrahlung, according to some embodiments;

FIG. 4 presents a flowchart of a method for depth-profiling of samples, which corresponds to specific embodiments of the method of FIG. 1, wherein the depth-profiling is three-dimensional;

FIGS. 5A and 5B schematically depict a sample undergoing depth-profiling in accordance with the method of FIG. 4, according to some embodiments thereof,

FIG. 6 schematically depicts a sample undergoing depth-profiling in accordance with the method of FIG. 4, according to some embodiments thereof,

FIG. 7 presents a system for depth-profiling of samples based on measurements of X-rays, according to some embodiments; and

FIG. 8 presents a method for training an algorithm to determine a set of structural parameters of a sample through application of a data analysis operation of the method of FIG. 1, according to some embodiments thereof.

### DETAILED DESCRIPTION OF THE INVENTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

The present application, according to some embodiments thereof, is directed at X-ray measurement-based methods and systems for non-destructive depth-profiling of a sample: Electron beams at each of a plurality of landing energies are projected on the sample. Each electron beam penetrates into the sample and excites emission of characteristic X-rays from a respective (probed) region within the sample. The greater the landing energy, the greater the depth about which the probed region is centered.

The present application teaches how X-ray emission data from multiple probed regions, which are centered about multiple depths, respectively, may be jointly processed to determine a set of structural parameters of a sample. In particular, the present application teaches how X-ray emission data from multiple probed regions, which are centered about multiple depths, respectively, may be jointly processed to generate a high-resolution concentration map of a (target) material included in a sample. According to some embodiments, the processing involves utilizing a trained algorithm, such as a (trained) neural network or even a (trained) linear model-incorporating algorithm (defined below). Advantageously, the present application further discloses methods whereby a neural network may be trained to perform such processing starting out from a small set of ground truth data. More precisely, the present application teaches how to amplify a small training set of (measured) ground truth data and associated actual X-ray measurement data (i.e. optical measurement data of X-rays) to obtain an arbitrarily larger training set of simulated “ground truth” data and associated simulated X-ray measurement data, which may be used to train the algorithm.

### Depth-Profiling Methods

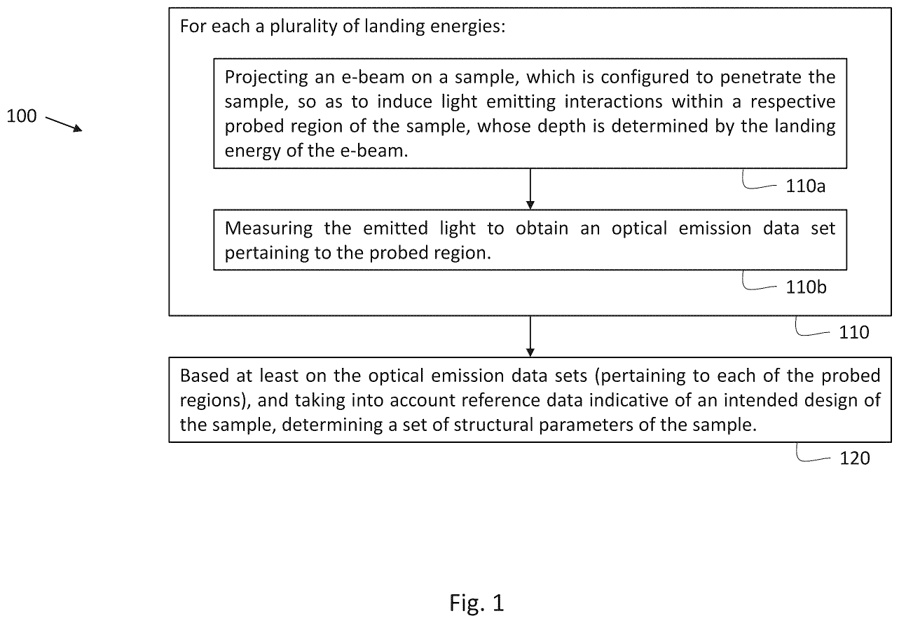

According to an aspect of some embodiments, there is provided a computer-based method for non-destructive depth-profiling of samples (such as patterned wafers and/or semiconductor structures, e.g. included in patterned wafers). FIG. 1 presents a flowchart of such a method, a method 100, according to some embodiments. Method 100 includes:
A measurement operation 110, which includes, for each of a plurality of landing energies, performing:
   A suboperation 110a, wherein an electron beam (e-beam) is projected on a sample (also referred to as “the inspected sample”), which is being depth-profiled. The e-beam is configured to penetrate the inspected sample, so as to induce light emitting interactions between electrons from the e-beam and matter (i.e. material) within a respective region (referred to as “the probed region”) of the inspected sample, whose depth is determined by the landing energy of the e-beam.
   A suboperation 110b, wherein the emitted light (i.e. the light generated by the light emitting interactions) is measured to obtain an optical emission data set pertaining to the probed region.
A data analysis operation 120, wherein a set of structural parameters, characterizing an internal geometry and/or a (material) composition of the inspected sample, is determined based on the measured optical emission data sets and taking into account reference data indicative of an intended design of the inspected sample.

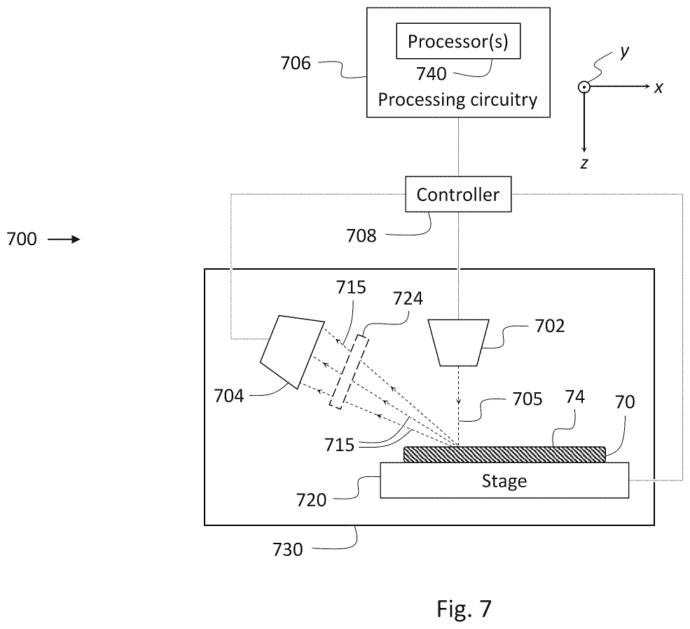

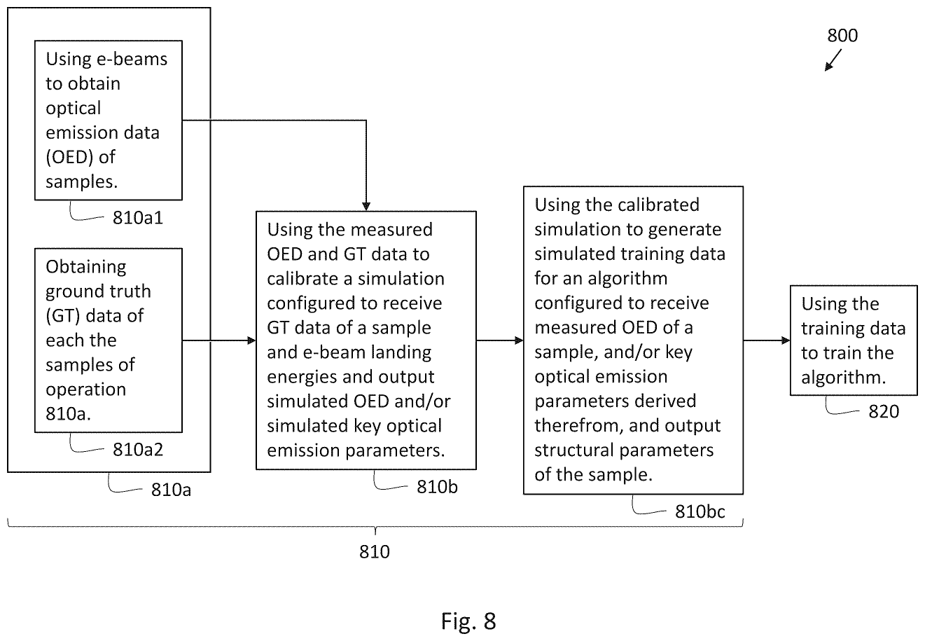

Method 100 may be implemented using a system, such as the system described below in the description of FIG. 7, or a system similar thereto.

According to some embodiments, and as described in detail below, data analysis operation 120 may involve utilizing an algorithm, which is configured to receive as inputs the optical emission data sets, and/or key optical emission parameters extracted from the optical emission data sets, and output the set of structural parameters. According to some embodiments, the algorithm is trained using training data, which include, or are derived from, the reference data. As used herein, the term “reference data” may refer to structural information, which specifies or is indicative of a nominal internal geometry, and/or a nominal composition, of an inspected sample, and which is initially available (i.e. prior to implementing method 100). The structural information may include (i) design data of the inspected sample and/or (ii) ground truth (GT) data, which is indicative of the intended design of the inspected sample. Such GT data may be obtained by profiling, potentially destructively (e.g. using scanning electron microscopy or transmission electron microscopy), other samples (also referred to as “GT samples”) of the same intended design as the inspected sample. According to some embodiments, the GT data may specify concentration maps of one or more materials (compounds and/or elements) nominally included in the GT samples. It is noted that GT data will typically slightly differ from design data in additionally reflecting production imperfections. According to some embodiments, the structural information may include “simulated” GT data, particularly, structural information pertaining to “simulated” samples of the same intended design as the inspected sample but which slightly differ from one another e.g. as would be expected due to manufacturing imperfections.

According to some embodiments, in order to improve the training of the algorithm, GT samples may be especially prepared so as to reflect the range of variation of a structural parameter, from a selected minimum value of the structural parameter to a selected maximum value thereof.

More specifically, according to some embodiments, the training data may include the reference data and associated actual measurement data and/or simulated measurement data. The actual measurement data may be derived by implementing measurement operation 110 with respect to other samples (i.e. GT samples) of the same intended design as the inspected sample or especially prepared samples exhibiting a selected variation(s) with respect to the intended design (i.e. nominal design). The simulated measurement data may be derived by simulating application of measurement operation 110 with respect to “simulated” samples of the same intended design as the inspected sample but which slightly differ from one another (e.g. as would be expected due to manufacturing imperfections).

As used herein, the term “structural parameter” is to be understood in a broad manner and, according to some embodiments, may refer to a geometrical parameter, such as the thickness of a layer of a layered sample, while, according to some other embodiments, may refer to a compositional parameter, such as an (overall) concentration of a (target) material included in an inspected sample. In particular, according to some embodiments, the term “set of structural parameters” may be used to refer to a set of parameters and/or a function specifying a concentration map (mass distribution or particle distribution) of a (target) material included in an inspected sample. As used herein, according to some embodiments, the term “set” may refer to a plurality of elements, while according to some other embodiments, the term “set” may refer to a single element. A specific instance of the former case is when the set is constituted by a function. According to some embodiments, each element of a set may represent a datum (e.g. a value of a parameter) or data (e.g. values of a plurality of parameters).

According to some embodiments, the inspected sample is a patterned wafer, a part of a patterned wafer, or a semiconductor device embedded in or on a patterned wafer, optionally, in one of the fabrication stages of the patterned wafer. According to some embodiments, the inspected sample is or includes a structure including one or more semiconductor materials. According to some embodiments, the structure may be constructed as part of the manufacturing process of a semiconductor device and/or a component(s) of a semiconductor device. According to some embodiments, the structure may be an assist structure, which is constructed as part of the manufacturing process of a semiconductor device and/or a component(s) of a semiconductor device. According to some embodiments, the inspected sample may be or include one or more logic components (e.g. a fin FET (FinFET) and/or a gate-all-around (GAA) FET) and/or memory components (e.g. a dynamic RAM and/or a vertical NAND (V-NAND)), optionally, in one of the fabrication stages thereof. According to some embodiments, the inspected sample is layered, including a plurality of layers. According to some such embodiments, the set of structural parameters includes a plurality of parameters characterizing each of at least some of the plurality of layers.

According to some embodiments, the set of structural parameters specifies a concentration map (density distribution) of a target material included in the inspected sample. According to some embodiments, the concentration map quantifies at least the depth dependence of (i) the mass density or relative mass density (i.e. percentage by weight per unit volume) of the target material or (ii) the particle density (e.g. atomic density) or relative particle density (e.g. atomic percent per unit volume) of the target material. The term “particles”, when employed in relation to a material, refers to one or more types of atoms and/or one or more types of molecules of which the target material is composed. The term “relative particle density”, when employed in relation to a first material (e.g. the target material), which is included in an inspected sample, refers to the ratio of the number particles—making up the first material—per unit volume to the total number of particles (i.e. of all the materials included in the inspected sample) per unit volume. According to some alternative embodiments, the concentration map characterizes at least a depth dependence of a function of both the mass density and the particle density.

According to some embodiments, at each map coordinate(s), the density of the target material is specified to within a respective density range from a plurality of density ranges. That is, the density may be specified by a non-negative integer, such that for any given specific value i of the non-negative integer the density is determined to a range [i·Δξ, (i+1)·Δξ], wherein Δξ is the magnitude of (each of) the ranges (i.e. the density resolution, as provided by the specific embodiment of method 100 which is employed).

Alternatively, according to some embodiments, at each map coordinate(s), the density of the target material is specified in terms of a numerical value from a continuous range of numerical values.

While the term “target material” has been used above to refer to a material (i.e. substance) whose density distribution is to be determined using method 100, more generally, the term “target material” may refer to a material, which is included in an inspected sample and whose spectrum, at least about one characteristic X-ray line of the material, is measured as part of measurement operation 110 (i.e. when method 100 is applied to the inspected sample) and is processed in data analysis operation 120 to determine, or as part of determining, the set of structural parameters.

According to some embodiments, the inspected sample may include a bulk, such as a semiconductor structure, into which the target material has been introduced in order to moderately modify one or more physical properties of the bulk (e.g. to increase electrical conductivity and/or capacitance). According to some such embodiments, the target material may include fluorine, nitrogen, boron, and/or gallium. According to some such embodiments, the target material may define a vertical gradient across the bulk. According to some embodiments, the bulk may include a plurality of thin layers stacked one on top of the other. Each of the layers may be composed of a respective bulk material(s) (e.g. a respective semiconductor material(s)). According to some embodiments, the inspected sample may be or include one or more memory components and/or logic components (such as a gate stack, for example, a high-k metal gate stack) and the target material may be or include fluorine, nitrogen, boron, and/or gallium.

As used herein, according to some embodiments, the term “intended design”, when employed in relation to an inspected sample including a bulk with a target material introduced thereinto, refers at least to the intended design of the bulk (e.g. as specified by design data thereof, or, more generally, reference data thereof). According to some such embodiments, the term “intended design” should be understood as additionally referring to the nominal density distribution of the target material within the bulk (including embodiments wherein the target material is introduced subsequently to the fabrication of the bulk).

Additionally, or alternatively, according to some embodiments, the set of structural parameters may include one or more of: (i) an average density (i.e. overall mass concentration and/or overall particle concentration) of at least one target material that the inspected sample includes; and (ii) at least one width of at least one target structure, respectively, which is embedded in the inspected sample. In embodiments wherein the inspected sample is layered (i.e. including a plurality of layers), the set of structural parameters may include or additionally include: (iii) at least one thickness of at least one of the layers; (iv) a combined thickness of at least some of the layers; (v) at least one average density (mass and/or particle) of at least one of the layers; and (vi) an average density (mass and/or particle), in at least one of the layers, of at least one target material (i.e. substance) that the inspected sample includes. More generally, the set of structural parameters may include any geometrical parameter and/or compositional parameter of the inspected sample whose modification impacts the spectra of the emitted light, which are measured in the implementations of suboperation 110b, so as to allow determining the value of the parameter based on the measured spectra.

It is noted that the task of determining the overall concentration of a target material may be less cumbersome than generating a concentration map of the target material. This applies both to measurement operation 110, wherein, according to some embodiments, comparatively fewer landing energies may be required (i.e. fewer implementations of suboperations 110a and 110b), and to data analysis operation 120, wherein, according to some embodiments, the involved data processing may be comparatively less cumbersome.

According to some embodiments, each of the structural parameters, or at least some of the structural parameters, may be specified to a respective range (of values) from a respective plurality of non-overlapping ranges, which may be complementary. For example, in embodiments wherein the set of structural parameters includes the thickness of a layer, in data analysis operation 120, the thickness may be determined by an integer (which according to some embodiments may be negative), such that, for any given specific value i of the integer, the thickness is determined to a range [t+i·Δt, t+(i+1)·Δt], wherein Δt is the magnitude of (each of) the ranges (i.e. the thickness resolution, as provided by the specific embodiment of method 100 which is employed).

According to some embodiments, each of the structural parameters, or at least some of the structural parameters, may be specified in terms of a respective numerical value from a respective continuous range of numerical values.

According to some embodiments, the emitted light is or includes X-rays, and, in particular, characteristic X-rays. Parameters of each e-beam, particularly the landing energy of the e-beam, are selected so as to induce in suboperation 110a emission of characteristic X-rays by particles (specifically, particles of one or more target materials) in a probed region centered about a respective depth, which is determined by the landing energy of the e-beam. The number of landing energies, and the minimum and maximum landing energies, may be selected to ensure that the inspected sample is probed over a range of depths. According to some such embodiments, the number of landing energies, and the minimum and maximum landing energies, may be selected to ensure that the inspected sample is probed all along the depth-dimension thereof.

Emitted X-ray light is measured in suboperation 110b to obtain an optical emission data set pertaining to the respective probed region (i.e. probed in the preceding implementation of suboperation 110a). More precisely, each probed region may correspond to a respective volume of the inspected sample, wherein electrons in the respective e-beam (probing the probed region) cause ejections of electrons in the inner shells of atoms (in the probed region), leaving each of these atoms with an inner shell vacancy. The inner shell vacancy may be filled through the relaxation of an outer shell electron to the inner shell. The relaxation may be accompanied by emission of a photon (having energy equal to the energy lost by the electron in transitioning from the outer shell to the inner shell).

According to some embodiments, suboperation 110b may be implemented using a spectrometer, which is configured to partially or fully a measure a spectrum (including intensities) of the emitted light (generated in suboperation 110a), thereby obtaining the respective optical emission data set. According to some embodiments, the spectrometer may be configured to measure light in the X-ray range. According to some such embodiments, suboperation 110b may be implemented using an energy-dispersive X-ray spectrometer or a wavelength-dispersive X-ray spectrometer.

More generally, according to some embodiments, in suboperation 110b one or more parameters of the emitted light may be measured, thereby obtaining the respective optical emission data set. According to some embodiments, the one or more measured parameters may include at least the number of emitted photons, of a specific frequency (corresponding to a characteristic X-ray line of a target material, e.g. the peak characteristic X-ray emission frequency of the target material) or in a frequency range (e.g. centered about the characteristic X-ray line of the target material), which exit the inspected sample and are sensed by the spectrometer. According to some embodiments, the one or more measured parameters may include the numbers of emitted photons, per each of a plurality of frequencies, or frequency ranges, corresponding to a plurality of characteristic X-ray lines of one or more target materials. As a non-limiting example, the plurality of frequencies may include the peak characteristic X-ray emission frequency of a target material (e.g. the frequency of the most intense line in the X-ray emission spectrum of the target material) and the frequency of the second tallest characteristic X-ray emission peak of the target material (e.g. the frequency of the second most intense line in the X-ray emission spectrum of the target material). Additionally, or alternatively, according to some embodiments, in addition to including one or more characteristic X-ray emission frequencies of a first target material, the plurality of frequencies may include one or more characteristic X-ray emission frequencies of at least one other target material besides the first target material.

According to some embodiments, and as elaborated on below, in data analysis operation 120, in addition to the intensities of one or more characteristic X-ray lines (pertaining to one or more target materials), parameters characterizing the “background” X-ray radiation—that is, a continuous contribution to the emitted X-ray light due to Bremsstrahlung—are also taken into account in determining the set of structural parameters (e.g. in generating the concentration map of a target material).

According to some embodiments, an image sensor may be used to sense the emitted light in each of the implementations of suboperation 110b, thereby obtaining the optical emission data sets. More specifically, in each implementation of suboperation 110b, the image sensor senses the emitted light to obtain one or more two-dimensional images. According to some embodiments, the image sensor may be configured to sense only light at a specific frequency (e.g. the peak characteristic X-ray emission frequency of a target material) or in a frequency range (e.g. centered about the peak characteristic X-ray emission frequency of the target material). According to some embodiments, the image sensor may be configured to sense only light at each of a plurality of frequencies (e.g. the peak characteristic X-ray emission frequency of a first target material, and the emission frequency corresponding to the second tallest characteristic X-ray peak of the first target material and/or the peak emission frequency of a second target material) or frequency ranges (e.g. centered about the peak characteristic X-ray emission frequency of the first target material, and the emission frequency of the second tallest characteristic X-ray peak of the first target material and/or the peak emission frequency of a second target material).

According to some embodiments, each pixel on the image sensor may be configured to partially or fully a measure a spectrum (e.g. in an X-ray range) of the emitted light (generated in suboperation 110a). That is, in such embodiments, each pixel functions as spectrometer.

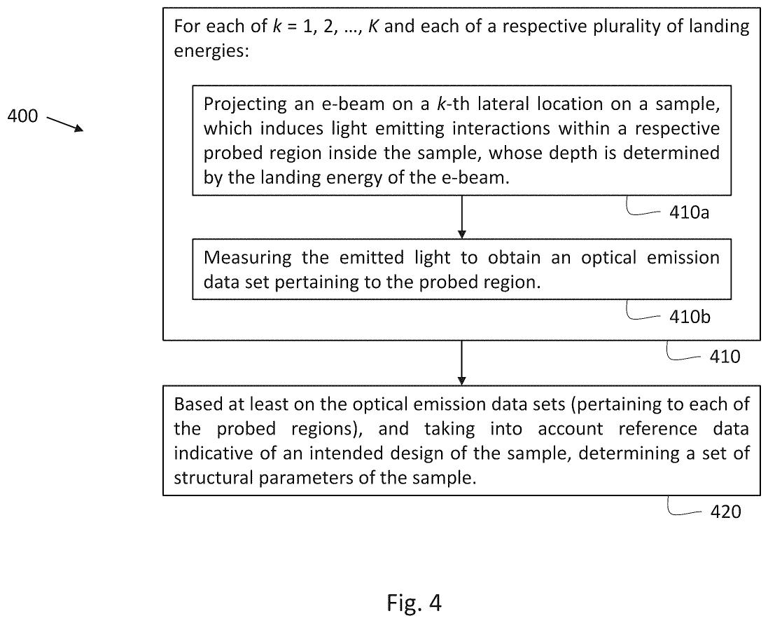

Method 100 may be used to provide a one-dimensional concentration map of a target material included in an inspected sample or a three-dimensional concentration map of a target material included in an inspected sample (or a two-dimensional concentration map of a target material included in a sample). Each possibility corresponds to separate embodiments. In the latter case (i.e. in embodiments wherein method 100 is used for three-dimensional profiling), and as described in detail below in the description of FIGS. 4-6, measurement operation 110 may be serially implemented with respect to each of a plurality of lateral (i.e. horizontal) locations on the inspected sample (e.g. on the top surface of the inspected sample) at which the respective e-beams impinge. The skilled person will also readily perceive that by serially implementing measurement operation 110 with respect to each of a plurality of lateral locations on an inspected sample, at which the respective e-beams impinge, lateral variations (i.e. variations in parallel to the xy-plane assuming the z-coordinate quantifies the depth) in the average concentration (the (local) density averaged over the depth dimension) of a target material may be detected. Accordingly, method 100 may be used to obtain a two-dimensional map of the average concentrations of one or more target materials may be obtained.

More generally, by serially implementing measurement operation 110 with respect to each of a plurality of lateral locations on an inspected sample, at which the respective e-beams impinge, and applying data analysis operation 120, variations in values of structural parameters (beyond the local concentration (i.e. density) of a target material or the average concentrations of one or more target materials) may be detected. For example, when the inspected sample is layered, lateral variations (e.g. due to process variation) in the thicknesses of layers may be detected. Accordingly, the lateral variation in the thickness of a layer may be presented in terms of a two-dimensional thickness map specifying the thickness as a function of the lateral coordinates.

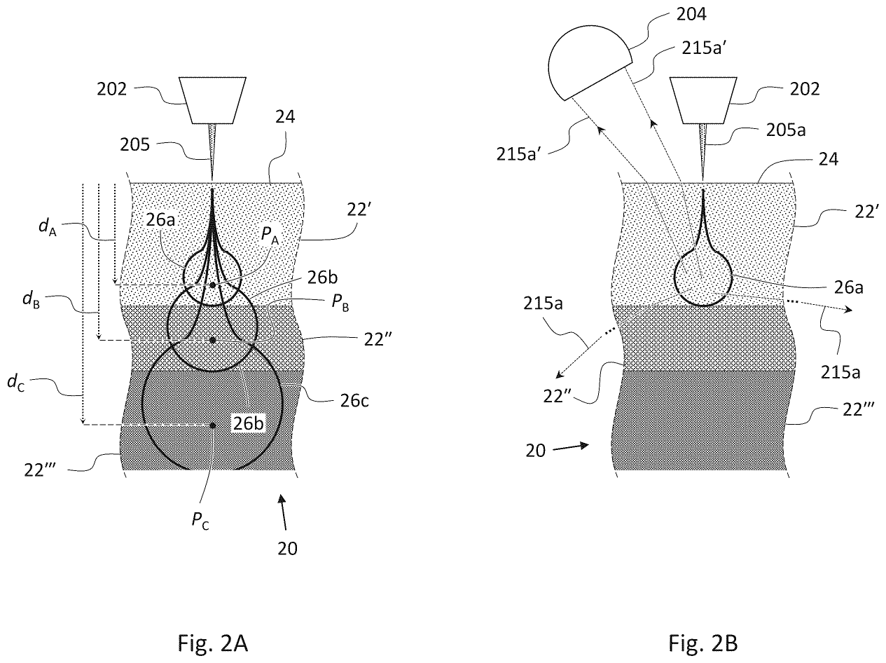

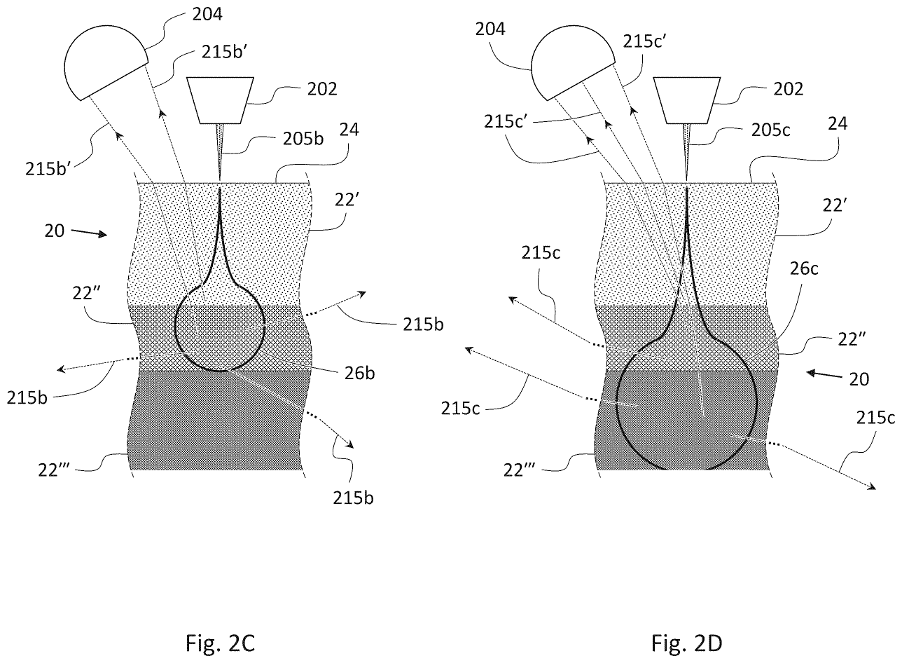

First, the one-dimensional case (i.e. pure depth-profiling without lateral characterization) is described in detail. To this end, reference is additionally made to FIGS. 2A-2D. FIGS. 2A-2D schematically depict an implementation of measurement operation 110 of method 100, according to some embodiments thereof, wherein one-dimensional information of an inspected sample is sought. To facilitate the description by rendering it more concrete, it is assumed that method 100 is employed to generate a one-dimensional concentration map of a target material included in an inspected sample (e.g. a semiconductor specimen). However, the skilled person will readily grasp the generalization to other tasks, such as the tasks mentioned above (e.g. determination of thicknesses of layers in a layered sample, the determination of lateral variations of average concentrations of one or more target materials, or the determination of the lateral dimensions of a target structure embedded in the inspected sample).

FIG. 2A shows a cross-sectional view of an (inspected) sample 20 being probed by an e-beam in accordance with measurement operation 110. As a non-limiting illustrative example, it is assumed that sample 20 includes a plurality of lateral (i.e. horizontal) layers 22 with at least some of layers 22 differing from one another in composition, whether in terms of bulk material and/or in the overall concentration of the target material. According to some embodiments, at least some of layers 22 may differ from one another in thickness.

As a non-limiting example, in FIGS. 2A-2D sample 20 is shown as including three layers disposed one on top of the other: a first layer 22′, a second layer 22″, and a third layer 22′″. First layer 22′ is disposed above second layer 22″. Second layer 22″ is sandwiched between first layer 22′ and third layer 22′″. The top surface of first layer 22′ constitutes an external surface 24 of sample 20. Also shown is an electron beam (e-beam) source 202 and an e-beam 205 produced thereby, so as to impinge (e.g. normally impinge) on external surface 24. E-beam source 202 is configured to project e-beams (one at a time) at each of a plurality of landing energies, thereby implementing suboperation 110a.

The greater the landing energy of e-beam 205, the greater the depth to which electrons from e-beam 205 will (on average) penetrate into sample 20. Further, the greater the landing energy of e-beam 205, the greater may be the probed region, that is, the volume within sample 20 wherein electrons from e-beam 205 interact with matter in sample 20 so as to induce emission of characteristic X-rays. This is exemplified in FIG. 2A via three probed regions 26: A first probed region 26a corresponds to the volume in which about all (e.g. at least 80%, at least 90%, or at least 95%) of the characteristic X-ray (i.e. X-ray light) emitting interactions will occur due to the penetration into sample 20 of an e-beam at a first landing energy E₁. A second probed region 26b corresponds to the volume in which about all of the characteristic X-ray emitting interactions will occur due to the penetration into sample 20 of an e-beam at a second landing energy E₂. A third probed region 26c corresponds to the volume in which about all of the characteristic X-ray emitting interactions will occur due to the penetration into sample 20 of an e-beam at a third landing energy E₃. First probed region 26a is centered about a first point P_{A} at a depth d_{A}, second probed region 26b is centered about a second point P_{B} at a depth d_{B}, and third probed region 26c is centered about a third point P_{C} at a depth d_{C}. E₁<E₂<E₃. Accordingly, d_{A}<d_{B}<d_{C}. According to some embodiments, and as depicted in FIG. 2A, third probed region 26c is of greater size than second probed region 26b, which is of greater size than first probed region 26a.

According to some embodiments, particularly embodiments wherein in data analysis operation 120 a NN is utilized to obtain the concentration map, the required depth resolution of the concentration map dictates the number of landing energies. In particular, the greater the required depth resolution, the greater the number of landing energies utilized. (The minimum and maximum depths, to which an inspected sample is probed, are determined by the smallest and greatest landing energies, respectively.) Accordingly, in such embodiments, the distances between centers of successive (probed) regions (e.g. the distance d_{B}−d_{A} between P_{A} and P_{B}, the distance d_{C}−d_{B} between P_{B} and P_{C}), are dictated by the required resolution of the concentration map. According to some embodiments, the depth resolution is selected to be sufficiently high to detect and “pin-point” changes in the depth-dependence of the concentration of the target material. For example, in the depth-profiling of sample 20, the depth resolution may be selected to be greater than the thickness of the thinnest of layers 22. It is noted that the same may apply also to other structural parameters. For example, according to some embodiments, the accuracy, to which the thicknesses of layers of a layered sample are to be determined, may dictate the number of landing energies.

Alternatively, according to some embodiments, wherein a linear model-incorporating algorithm (i.e. an algorithm constituted by a linear regression model or incorporating a linear regression model as a sub-algorithm) may be employed in data analysis operation 120 to obtain the concentration map (and, more generally, the set of structural parameters), the number of landing energies employed may be comparatively much smaller. That is, the inspected sample may be probed to each of a small set of preselected and/or random depths (e.g. to capture process variation).

As used herein, the term “linear model-incorporating algorithm” may refer to a linear-model or, more generally, an algorithm incorporating two or more sub-algorithms with one of the sub-algorithms being constituted by a linear model. According to some embodiments, wherein the linear model is configured to receive as inputs a set of structural parameters \vec{p}′ and output key optical emission parameters \vec{f}_{key}′(\vec{p}′), the linear model-incorporating algorithm may involve execution of an optimization algorithm (e.g. least squares), whereby the determined set of structural parameters 3 is obtained as the solution of argmin_{\vec{p}′}∥\vec{f}_{key}−\vec{f}_{key}′(\vec{p}′)∥. Here \vec{f}_{key} specifies the key optical emission parameters derived from the measured optical emission data sets and the double vertical brackets denote a norm (e.g. L²). Each component of \vec{f}_{key}′(\vec{p}′) may be a function of one or more of the components of \vec{p}′. Most generally, each component of \vec{f}_{key}′(\vec{p}′) may be a multi-variable function of the components of \vec{p}′. Further, the term “linear model” is to be understood as not limited to linear functions whose weights are determined using least squares. According to some embodiments, other norms may be utilized to fix the weights, such as the L¹ norm or the Mahalanbois distance. According to some embodiments, a regularizing term(s) may be added to the norm ∥\vec{f}_{key}−\vec{f}_{key}′(\vec{p}′) to stabilize the solution or as a constraint(s), which reflects some prior knowledge about the X-ray emission spectra. As used herein, the terms “linear model” and “linear regression model” are interchangeable.

More specifically, a linear model-incorporating algorithm may be employed in embodiments wherein key optical emission parameters—derived from the optical emission data sets and based on which the set of structural parameters is determined—are expected to exhibit a substantial linear dependence on the structural parameters (at least over the range over which the structural parameters are expected to vary). The linear model (i.e. the linear model-incorporating algorithm or a sub-algorithm thereof) may describe the impact of one or more internal geometry parameters and/or one or more concentration parameters on the spectrum of emitted X-ray radiation or at least the intensities of one or more characteristic X-ray lines. Accordingly, after training the linear model (i.e. learning the dependence of the emitted X-ray radiation about one or more characteristic X-ray lines on the internal geometry parameter(s) and/or the concentration parameter(s), X-ray radiation from an inspected sample may be measured and one or more structural parameters of the inspected specimen may be estimated. In the context of generating a concentration map of a target material, a linear model-incorporating algorithm may be employed in embodiments wherein the density of the target material is sufficiently small such that the intensity of X-ray radiation, which is emitted due to the presence of the target material, exhibits a substantial linear dependence on the density of the target material. In particular, if the density of the target material at a depth dis increased by a factor α, the contribution to the intensity of the X-ray radiation, due to the target material present at the depth d, will substantially increase by the factor α.

Typically, the number of different GTs required for training a linear model may be smaller by one to two orders of magnitude than required for training a NN. To this end, according to some embodiments, wherein key optical emission parameters are expected to exhibit a dependence on the (values of the) structural parameters, that is not close to linear, actual GT and associated measured optical emission data may be amplified through simulation to obtain a large simulated training set (for training the NN), as described below in the Training Methods Subsection below.

Referring to FIG. 2B, a first e-beam 205a—generated by e-beam source 202 and having the first landing energy E₁—is shown incident on sample 20. Also delineated is first probed region 26a (in which about all the characteristic X-ray emitting interactions, induced by first e-beam 205a, occur). X-rays may be emitted in all directions, as exemplified by X-rays 215a. X-rays 215a′ indicate X-rays (from X-rays 215a), which arrive at a light sensor 204.

FIG. 2C shows a second e-beam 205b—generated by e-beam source 202 and having the second landing energy E₂—incident on sample 20. Also delineated is second probed region 26b (in which about all the characteristic X-ray emitting interactions, induced by second e-beam 205b, occur). X-rays may be emitted in all directions, as indicated by X-rays 215b. X-rays 215b′ indicate X-rays (from X-rays 215b), which arrive at light sensor 204.

FIG. 2D shows a third e-beam 205c—generated by e-beam source 202 and having the third landing energy E₃—incident on sample 20. Also delineated is third probed region 26c (in which about all the characteristic X-ray emitting interactions, induced by third e-beam 205c, occur). X-rays may be emitted in all directions, as indicated by X-rays 215c. X-rays 215c′ indicate X-rays (from emitted X-rays 215c), which arrive at light sensor 204.

While in FIGS. 2B-2D, layers 22 are depicted as differing from one another in their respective refractive indices (as evinced by the refraction of the light rays on transition from one layer to another), it is to be understood that method 100 is equally applicable without such differences being present.

For each of the landing energies (e.g. landing energies E₁, E₂, and E₃), respective optical emission data sets (including characteristic X-ray emission data) may be obtained by light sensor 204, thereby implementing suboperation 110b. Each optical emission data set may contain information regarding the overall concentration of the target material (and, more generally, any number of target materials) in the respectively probed region. By obtaining a plurality of optical emission data sets, pertaining to a sufficiently large number of (different) landing energies, and analyzing the plurality of optical emission data sets (for example, using a trained neural network, or, according to some embodiments, a trained linear model-incorporating algorithm), the dependence of the concentration of the target material on the depth may be extracted (in data analysis operation 120), and, more generally, the value of a structural parameter, such as the thickness of a layer in a layered sample, may be obtained.

Intuitively, since each material is characterized by a unique set of spectral lines (in the X-ray range) corresponding to the energy differences between orbitals of elements and/or compounds making up the material, a probed region, which includes a plurality of different materials, will be characterized by a composite set of spectral lines that is a combination of the sets of spectral lines characterizing each of the materials. The ratios of the measured intensities of the spectral lines of a first material (e.g. introduced into the sample), which is included in the probed region, to the measured intensities of the spectral lines of a second material (e.g. a semiconductor), which is included in the probed region, depend on the ratio of their overall concentrations within the probed region. The greater the concentration of a material, the greater the measured intensity of the spectral lines pertaining thereto.

For each probed region, the overall concentration of a (target) material therein may, in principle, be obtained from the measured intensities of spectral lines (characteristic X-ray lines) associated therewith and, optionally, the shapes of the spectra in immediate vicinities of the spectral lines (from which the bremsstrahlung may be estimated). To obtain more localized information (i.e. the spatial dependence of the concentration to higher resolution than the dimensions of the probed region), emission spectra of other probed regions may be taken into account. The skilled person will readily appreciate that this intuition applies also for other tasks, such as, for example, the determination of the thicknesses of layers in a layered structure.

Referring again to data analysis operation 120, according to some embodiments, as detailed above and in further detail below, the set of structural parameters may be obtained as the output of a trained algorithm (i.e. an algorithm derived using machine-learning (ML) tools, also referred to as “ML-derived algorithm”), such as a (trained) neural network (NN), or, according to some embodiments, a (trained) linear model-incorporating algorithm. According to some embodiments, as detailed above and in further detail below, the algorithm may be configured to receive as inputs key optical emission parameters. The key optical emission parameters are derived from the optical emission data sets (obtained in each of the implementations of suboperations 110a and 110b). Accordingly, data analysis operation 120 may include an initial suboperation wherein the key optical emission parameters are derived. According to some embodiments, each key optical emission parameter may be derived from a respective one of the optical emission data sets. According to some such embodiments, each key optical emission parameter may be labelled by the landing energy at which the respective optical emission data set (from which the key optical emission is derived) was obtained.

According to some embodiments, the key optical emission parameters are obtained from (i.e. are functions of) the measured spectra of characteristic X-ray lines. More specifically, and as described in detail below, according to some embodiments, the derivation of the key optical emission parameters from the optical emission data sets, in data analysis operation 120, may involve an intermediate suboperation of extracting parameters, which characterize the measured spectra. The key optical emission parameters are then obtained from (i.e. are functions of) these extracted parameters. According to some embodiments, at least some of the key optical emission parameters may be derived based on one or more parameters, which characterize the shape of a spectral peak about a respective characteristic X-ray line. According to some embodiments, the key optical emission parameters are constituted by, or include, the so-called “energy signature”. According to some embodiments, each component of the energy signature may correspond to an absolute, normalized, or relative intensity of a respective characteristic X-ray line. Each possibility corresponds to separate embodiments. According to some embodiments, each component of the energy signature may correspond to an intensity of a respective characteristic X-ray line normalized by a mean background intensity about the characteristic X-ray line. Various ways, whereby the energy signature may be derived, are described next.

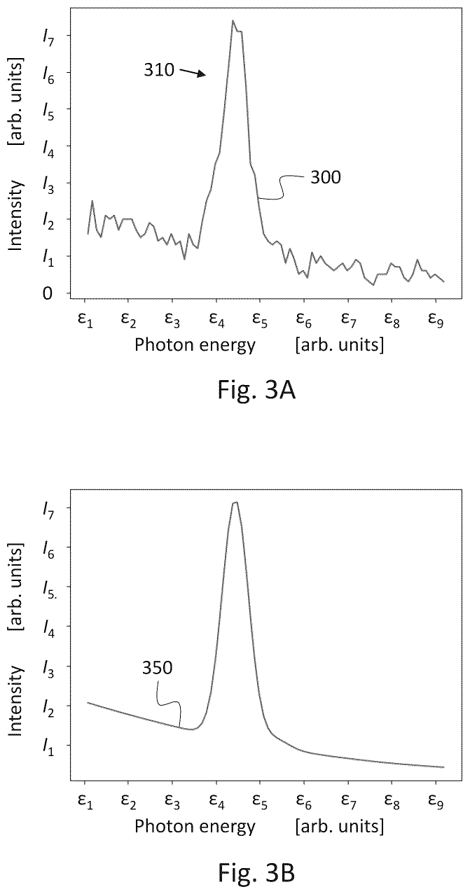

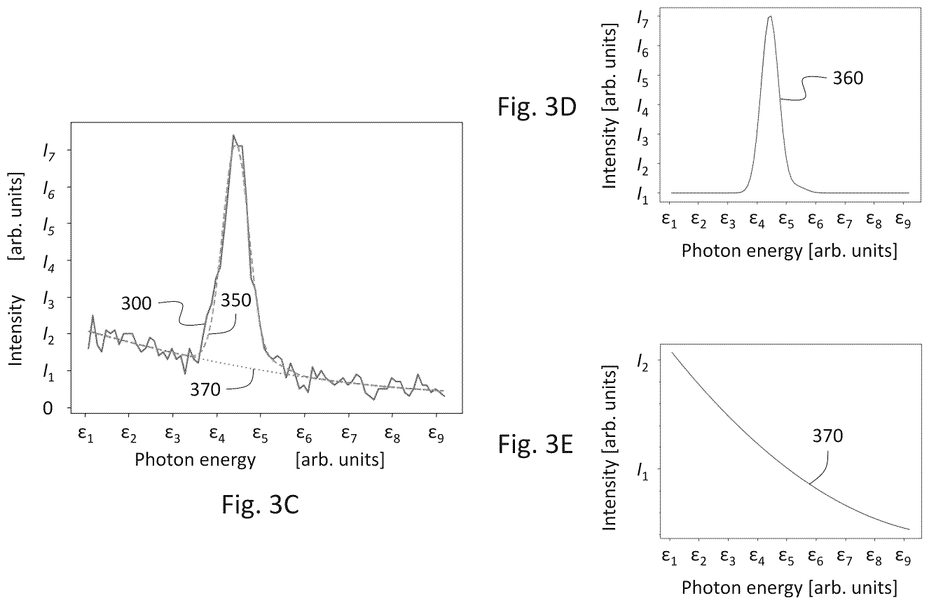

According to some embodiments, in order to derive \vec{f}_{key} (i.e. the set of key optical emission parameters), onto each of the X-ray emission spectra (obtained for each of the e-beams projected in measurement operation 110) a respective curve is fitted. This is illustrated by way of example in FIGS. 3A-3E, according to some embodiments, in the case wherein \vec{f}_{key} is given by the energy signature corresponding to a single target material and a single spectral line (i.e. a single characteristic X-ray line). The more general case, wherein the energy signature corresponds to a plurality of target materials, and/or, wherein for at least some of the target materials the energy signature corresponds to a plurality of spectral lines of each, is described later on.

Referring to FIG. 3A, FIG. 3A depicts a measured (X-ray emission) spectrum 300, which was obtained by implementing measurement operation 110 with respect to an inspected sample (e.g. sample 20). As is also the case in each of FIGS. 3B-3E, the horizontal axis corresponds to the photon energy ε (or equivalently the frequency) of the emitted X-rays and the vertical axis to the intensity I of the emitted X-rays. The graduations on each of the horizontal and vertical axes are linearly spaced-apart with εᵢ<εᵢ₊₁ and Iᵢ<Iᵢ₊₁. A peak 310 of measured spectrum 300 is substantially centered about a characteristic X-ray line of a target material, which is included in the inspected sample, and whose energy signature is to be obtained. FIG. 3B depicts an optimized curve 350, which was fitted onto measured spectrum 300. FIG. 3C depicts optimized curve 350 superimposed on measured spectrum 300.

According to some embodiments, the fitting onto measured spectrum 300 involves optimizing over values of one or more adjustable parameters of a curve (also referred to as the “free curve”), thereby obtaining optimized curve 350. The values of the one or more adjustable parameters are fixed by minimizing a distance between the free curve and the measured spectrum over the one or more adjustable parameters.

The one or more adjustable parameters may include a (first) adjustable parameter whose value is indicative of an intensity of the emitted X-rays about the characteristic X-ray line of the target material. According to some such embodiments, the adjustable parameter is a multiplicative coefficient of a normalized cap-shaped function (e.g. a normalized gaussian), which may be centered about, or exactly centered about, the characteristic X-ray line. According to some embodiments, the one or more adjustable parameters include a plurality of adjustable parameters, which may include—in addition to the first adjustable parameter—an additive bias parameter, at least one parameter governing a shape of the cap-shaped function (e.g. the width of a normalized gaussian), and/or a (characteristic X-ray) line shift parameter governing the location of the center of the cap-shaped function.

More generally, according to some embodiments, the free curve may be a sum of at least two adjustable functions: an adjustable cap-shaped function, which may be centered about the characteristic X-ray line, and an adjustable second function quantifying the (continuous) spectrum of the bremsstrahlung (i.e. background radiation) component of the respective measured X-ray emission spectrum (e.g. the background radiation in the vicinity of the characteristic X-ray line). As a non-limiting example, the at least one landing energy includes M e-beam landing energies {Eₘ}ₘ₌₁^{M}, so that MX-ray emission spectra are measured: {sₘ(ε)}ₘ₌₁^{M}. Here ε denotes the photon energy of the emitted X-rays and sₘ(ε)—the m-th measured X-ray emission spectrum—is the measured X-ray emission spectrum induced by projecting on the inspected sample an e-beam at the landing energy Eₘ. According to some embodiments, a set of M free curves {cₘ(ε)}ₘ₌₁^{M} may be fitted onto the set of measured spectra {sₘ(ε)}ₘ₌₁^{M}. According to some embodiments, for each 1≤m≤M, cₘ(ε)=Gₘ(ε)+bₘ(ε), wherein Gₘ(ε) is the adjustable cap-shaped function and bₘ(ε) is the adjustable second function (e.g. quantifying the background radiation). Gₘ(ε)=aₘ·gₘ(ε), wherein gₘ(ε) is a normalized cap-shaped function and aₘ is a multiplicative coefficient. According to some embodiments, gₘ(ε) may be a (normalized) gaussian, in which case the width and, optionally, the center of gₘ(ε) may be adjustable parameters (over which the optimization is carried out). According to some alternative embodiments, gₘ(ε) may be a (normalized) gamma distribution or generalized gaussian distribution. According to some embodiments, bₘ(ε) may be a polynomial (e.g. a first order polynomial or a second order polynomial) whose coefficients are adjustable. Alternatively, according to some embodiments, bₘ(ε) may be determined from Kramer's law.

Since gₘ(ε) is normalized, aₘ substantially equals the intensity of the X-rays (or equivalently the number of photons), (i) which are emitted due to transitions that correspond to the characteristic X-ray line of the target material, and (ii) which are detected by the light sensor (e.g. light sensor 204).

Denoting by {g_{m, i}}ᵢ₌₁ⁱ^{ₘₐₓ} and {b_{m, j}}ⱼ₌₀^{j}^{ₘₐₓ} the adjustable parameters of gₘ(ε) and bₘ(ε), respectively, for each 1≤m≤M, the optimized values ãₘ, {\tilde{g}_{m, i}}ᵢ₌₁ⁱ^{ₘₐₓ}, and {\tilde{b}_{m, j}}ⱼ₌₀^{j}^{ₘₐₓ} of the adjustable parameters may be obtained by minimizing D(cₘ(ε), sₘ(ε)) over aₘ, {g_{m, i}}ᵢ₌₁ⁱ^{ₘₐₓ}, and {b_{m, j}}ⱼ₌₀^{j}^{ₘₐₓ}. D(cₘ(ε), sₘ(ε)) is a distance between cₘ(ε) and sₘ(ε). As a non-limiting example, according to some embodiments, wherein gₘ(ε) is gaussian and bₘ(ε) is a second order polynomial: (i) {g_{m, i}}ᵢ₌₁²={g_{m, 1}, g_{m, 2}} with g_{m, 1} and g_{m, 2} parameterizing the width and location of the center of the gaussian; and (ii) {b_{m, j}}ⱼ₌₀²={b_{m, 0}, b_{m, 1}, b_{m, 2}} with b_{m, 0}, b_{m, 1}, and b_{m, 2} being the zeroth order, first order, and second order coefficients of the polynomial. In particular,

$${\tilde{a}}_{m} = arg {min}_{{a}_{m}} {min}_{{\{ {g}_{m , i} \}}_{i = 1}^{{i}_{max}} , {\{ {b}_{m , j} \}}_{j = 0}^{{j}_{max}}} D ( {c}_{m} ( ε ) , {s}_{m} ( ε ) ) .$$

According to some embodiments, D(cₘ(ε), sₘ(ε))=∫dε|cₘ(ε)−sₘ(ε)|² (or a discretized equivalent expression). According to some embodiments, a regularization term may be added to D(cₘ(ε), sₘ(ε)) to take into account prior knowledge regarding any of the free parameters and/or stabilize the solution (of the minimization algorithm).

According to some alternative embodiments, wherein there exists prior knowledge relating at least some of the free parameters to one another, the full set of optimized values, i.e.

$${\{ {\tilde{a}}_{m} , {\{ {\tilde{g}}_{m , i} \}}_{i = 1}^{{i}_{max}} , {\{ {\tilde{b}}_{m , j} \}}_{j = 0}^{{j}_{max}} \}}_{m = 1}^{M}$$

(or equivalently {ãₘ, \tilde{g}ₘ(ε), \tilde{b}ₘ(ε)}ₘ₌₁^{M}, wherein \tilde{g}ₘ(ε) and \tilde{b}ₘ(ε) denote the optimized functions defined by {\tilde{g}_{m, i}}ᵢ₌₁ⁱ^{ₘₐₓ} and {\tilde{b}_{m, j}}ⱼ₌₀^{j}^{ₘₐₓ}, respectively) is obtained by jointly optimizing over all the adjustable parameters, i.e.

$${\{ {\tilde{a}}_{m} , {\{ {\tilde{g}}_{m , i} \}}_{i = 1}^{{i}_{max}} , {\{ {\tilde{b}}_{m , j} \}}_{j = 0}^{{j}_{max}} \}}_{m = 1}^{M}$$

subject to constraints imposed by the aforementioned prior knowledge. More specifically, in such embodiments,

$${\{ {\tilde{a}}_{m} \}}_{m = 1}^{M} = arg {min}_{{\{ {a}_{m} \}}_{m = 1}^{M}} {min}_{{\{ {\{ {g}_{m , i} \}}_{i = 1}^{{i}_{max}} , {\{ {b}_{m , j} \}}_{j = 0}^{{j}_{max}} \}}_{m = 1}^{M}} {\sum }_{m = 1}^{M} D ( {c}_{m} ( ε ) , {s}_{m} ( ε ) )$$

$$s . t . {\{ {Q}_{l} \}}_{l = 1}^{{l}_{max}} ,$$

wherein {Qₗ}ₗ₌₁^{l}^{ₘₐₓ} is a set of lₘₐₓ constraints (i.e. each of the Qₗ is an equation, or inequality, relating at least some of the free parameters to one another).

As a non-limiting example, according to some embodiments, depicted in FIGS. 3B-3E, the free curve is a sum of three adjustable functions. In addition to gₘ(ε), which is gaussian, and bₘ(ε), which is a second order polynomial, the sum additionally includes a gaussian Yₘ(ε). Referring to FIG. 3D, a curved line 360 corresponds to ãₘ·\tilde{g}ₘ(ε)+\tilde{Y}ₘ(ε). \tilde{Y}ₘ(ε) (which is also gaussian) was obtained by optimizing over free parameters of Yₘ(ε). \tilde{g}ₘ(ε) is centered about the characteristic X-ray line of the target material. \tilde{Y}ₘ(ε) is centered about a characteristic X-ray line of a second material, which is present in the inspected sample. The characteristic X-ray line of the second material is close to the characteristic X-ray line of the target material and accordingly was taken into account in order to improve the accuracy of the classification. Referring to FIG. 3E, a curved line 370 corresponds to \tilde{b}ₘ(ε). Curved line 370 is also plotted in FIG. 3C.

According to some embodiments, wherein the X-ray emission spectrum about a single characteristic X-ray line of a single target material (included in the inspected sample) is used to determine \vec{f}_{key}, the number of components of \vec{f}_{key} is equal to the number of landing energies. According to some embodiments, for each 1≤m≤M, f_{key}^{(m)} is equal to ãₘ—the m-th component of the energy signature. More generally, according to some embodiments, for each 1≤m≤M, f_{key}^{(m)}=f_{key} (ãₘ{\tilde{b}_{m, j}}ⱼ₌₀^{j}^{ₘₐₓ}, wherein f_{key} (ãₘ, {\tilde{b}_{m, j}}ⱼ₌₀^{j}^{ₘₐₓ} is a function of ãₘ and {\tilde{b}_{m, j}}ⱼ₌₀^{j}^{ₘₐₓ}. That is, for each 1≤m≤M, the m-th component of the energy signature is a function of both ãₘ and the coefficients of \tilde{b}ₘ(ε). According to some such embodiments, f_{key} (ãₘ, {\tilde{b}_{m, j}}ⱼ₌₀^{j}^{ₘₐₓ})=f_{key} (ãₘ, q({\tilde{b}_{m, j}}ⱼ₌₀^{j}^{ₘₐₓ})), wherein q is a function of the coefficients of \tilde{b}ₘ(ε). As a non-limiting example, according to some embodiments, q({\tilde{b}_{m, j}}ⱼ₌₀^{j}^{ₘₐₓ})= [symbol] \tilde{b}ₘ(ε) [symbol] and f_{key} (ãₘ, q({\tilde{b}_{m, j}}ⱼ₌₀^{j}^{ₘₐₓ}))=ãₘ/ [symbol] \tilde{b}ₘ(ε) [symbol] , wherein the triangular brackets denote averaging about the center of \tilde{g}ₘ(c) along an interval equal to the width of \tilde{g}ₘ(ε).

According to some embodiments, the key optical emission parameters may be derived based on a dependence of the intensities of the emitted X-rays, about each of a plurality of different characteristic X-ray lines, on the landing energy. According to some such embodiments, wherein N_{c} is the number of different characteristic X-ray lines, the key optical emission parameters are specified by a M×N_{c} component vector with components f_{key}^{(m,n}^{_{c}}⁾ with 1≤m≤M and 1≤n_{c}≤N_{c}. The first index denotes the landing energy (M being the number of landing energies) and the second index denotes the characteristic X-ray line. That is, \vec{f}_{key}=(f_{key}^{(1,1)}, f_{key}^{(1,2)}, . . . , f_{key}^{(1,N}^{_{c}}⁾, f_{key}^{(2,1)}, f_{key}^{(2,2)}, . . . , f_{key}^{(2,N}^{_{c}}⁾, . . . , f_{key}^{(M,1)}, f_{key}^{(M,2)}, . . . , f_{key}^{(M,N}^{_{c}}⁾). In such embodiments, in measurement operation 110, for each landing energy, the X-ray emission spectrum is measured over a photon energy range, or photon energy ranges, including the plurality of characteristic X-ray lines. The components of \vec{f}_{key} pertaining to a same characteristic X-ray line (e.g. f_{key}^{(1,2)}, f_{key}^{(2,2)}, . . . , f_{key}^{(M,2)}) may be obtained as described above in the case wherein N_{c}=1. According to some embodiments, wherein the energy signature corresponds to a plurality of Nₜ (Nₜ≤N_{c}) target materials (which are included in the inspected specimen), the N_{c} characteristic X-ray lines include characteristic X-ray lines corresponding to each of the Nₜ target materials, respectively.

Generally, data analysis operation 120 may involve the use of a trained NN to obtain the set of structural parameters. However, when the key optical emission parameters substantially linearly depend on (each of the one or more) structural parameters, which are to be determined, a trained linear model-incorporating algorithm may be employed instead. It is to be understood that the linear dependence does not have to be absolute but rather it may suffice that the key optical emission parameters statistically exhibit substantial linear dependence on the structural parameters over the ranges the structural parameters are expected vary (e.g. due to manufacturing imperfections): for example, over [ [symbol] \vec{p} [symbol] −\vec{σ}, [symbol] \vec{p} [symbol] +\vec{σ}], wherein the vector \vec{p} specifies the set of structural parameters, the triangular brackets denote averaging over \vec{p}, and \vec{σ} is a vector specifying the standard deviations of each of the components of \vec{p}. In this regard, it is noted that whether or not a first parameter (e.g. a key optical emission parameter) statistically exhibits substantial linear dependence on a second parameter(s) (e.g. a structural parameter(s), which is to be determined), over the range(s) the second parameter(s) is expected to vary, depends on the required accuracy to which the second parameter(s) is to be determined. The same behavior may be considered substantially linear (and therefore approximated as linear) when a first accuracy is required but nonlinear (and therefore not amenable to treatment using a linear model-incorporating algorithm) when a second accuracy, which is higher than the first accuracy, is required.

According to some embodiments, wherein the set of structural parameters specifies a concentration map of a target material included in the inspected sample, and at each map coordinate the concentration map specifies the density of the target material to within a respective density range from a plurality of density ranges, the NN (when data analysis operation 120 is implemented using a NN) may be a classification NN or the linear model-incorporating algorithm (when data analysis operation 120 is implemented using a linear model-incorporating algorithm) may involve implementing a linear classifier. According to some embodiments, the density ranges may be complimentary in the sense of jointly constituting a continuous range of densities.

According to some embodiments, wherein each of the set of structural parameters is to be determined to a (single) numerical value (rather than a range; e.g. when a concentration map of a target material is to be generated such that at each map coordinate(s) the concentration map specifies the density of the target material to a respective numerical value), the NN (when data analysis operation 120 is implemented using a NN) may be a regression NN.

According to some embodiments, the NN may be a deep NN (DNN), such as a convolutional NN (CNN) or a fully connected NN. According to some embodiments, the NN may be composed of a variational autoencoder (VAE) and a classifier (for example, a support vector machine (SVM) or a DNN). In such embodiments, the optical emission data sets, and/or the key optical emission parameters, may be input into the VAE, which is configured to extract therefrom latent variables. The latent variables, each labelled by the respective landing energy, serve as inputs to the classifier, which is configured to output the (determined) set of structural parameters (e.g. the concentration map). Alternatively, according to some embodiments, the NN may be a multi-head VAE. According to some embodiments, the NN may be a generative adversarial network (GAN). According to some embodiments, wherein the NN is a classification NN, the NN may be a VGG NN or a ResNet.

According to some embodiments, wherein a concentration map of a target material is to be generated and the generating algorithm (e.g. an NN or a linear model-incorporating algorithm) is configured to receive as an input the energy signature, the energy signature may correspond to: (i) a single characteristic X-ray line of the target material (e.g. the peak characteristic X-ray line), (ii) two or more characteristic X-ray lines of the target material (e.g. the peak characteristic X-ray line and the second tallest characteristic X-ray line), or (iii) one or more characteristic X-ray lines of the target material being profiled (i.e. whose concentration map is to be generated) and a characteristic X-ray line(s) of another target material(s).

The Training Methods Subsection below describes various ways whereby an algorithm, such as an NN, may be trained to determine a set of structural parameters of an inspected sample (in particular, a concentration map of a target material included in the inspected sample) from key optical emission parameters (and, more generally, optical emission data sets) of the inspected sample, which pertain to a plurality of e-beam landing energies (i.e. landing energies of the e-beams), respectively.

According to some embodiments, wherein a spectrometer is used to obtain the optical emission data sets, data analysis operation 120 may include an initial preprocessing suboperation, wherein the optical emission data may be preprocessed to remove noise.

The skilled person will perceive that method 100 may be used to validate the nominal density distribution of a material in a sample, and, more generally, the nominal values of structural parameters characterizing a sample (e.g. nominal thicknesses of layers in a layered sample). In particular, method 100 may be used to quantify small variations (e.g. to within 1%, 3%, or even 5%) from a nominal density distribution of a material in a sample. The nominal density distribution is known and is taken into account in data analysis operation 120 in computing the variations. According to some embodiments, at each map coordinate(s) the concentration map may specify the difference between the actual density and the nominal density (which may be specified in terms of mass density, relative mass density, particle density, or relative particle density). According to some embodiments, at each map coordinate(s) the concentration map may specify the actual density (which may be specified in terms of mass density, relative mass density, particle density, or relative particle density)—i.e. the density computed in data analysis operation 120. It is noted that the validated material (i.e. the material whose nominal concentration map is validated) is not limited to materials, such as nitrogen and fluorine, which are typically introduced into a semiconductor bulk. According to some embodiments, the material, whose nominal density distribution is to be validated, may be a semiconductor material. According to some embodiments, method 100 may be used to validate the nominal density distributions of two or more materials included in a sample.

FIG. 4 presents a flowchart of a method 400 for three-dimensional profiling of samples. Method 400 corresponds to specific embodiments of method 100. Method 400 includes:
A measurement operation 410, wherein, for each (integer) k from 1 to N_{\vec{L}}, and for each of a respective plurality of landing energies (that is, different k may have associated therewith different pluralities of landing energies, which may differ in values and/or in number):
   A suboperation 410a, wherein an e-beam is projected on a sample (also referred to as “the inspected sample”) at a k-th lateral location on the inspected sample. The e-beam is configured to penetrate the inspected sample so as to induce light-emitting interactions between electrons from the e-beam and matter (i.e. material) within a respective region (referred to as “the probed region”) of the inspected sample, whose depth is determined by the landing energy of the e-beam.
   A suboperation 410b, wherein the emitted light is measured to obtain an optical emission data set pertaining to the probed region.
A data analysis operation 420, wherein a set of structural parameters, characterizing an internal geometry and/or a composition of the inspected sample, is determined based on the measured optical emission data sets and taking into account reference data indicative of an intended design of the inspected sample.

The skilled person will readily perceive that the order at which the above operations and suboperations are listed is not unique. Other applicable orders are also covered by the present disclosure. For example, according to some embodiments, data analysis operation 420 may be commenced prior to the conclusion of measurement operation 410.

Method 400 may be implemented using a system. such as the system described below in the description of FIG. 7, according to some embodiments thereof, or a system similar thereto.

According to some embodiments, the set of structural parameters specifies a three-dimensional concentration map of a target material included in the inspected sample. The skilled person will perceive that method 400 may also be employed to obtain a two-dimensional (defined by the depth dimension and a lateral dimension) concentration map of a target material in an inspected sample.

According to some embodiments, the set of structural parameters specifies a two-dimensional map that maps lateral variations in the average concentration (wherein the average is taken over the depth dimension) of a target material included in the inspected sample. According to some embodiments, wherein the inspected sample is layered, the set of structural parameters specifies a two-dimensional map that maps lateral variations in the thickness of a layer of the inspected sample. That is, the two-dimensional map specifies the thickness of the layer as a function of the lateral coordinates.

According to some embodiments, wherein a concentration map of a target material included in the inspected sample is to be generated, in data analysis operation 420, the optical emission data sets, or key optical emission parameters respectively derived from each of the optical emission data sets, may be subject to an integrated analysis in the sense that optical emission data sets of probed regions, which are laterally displaced with respect to a given probed region (e.g. laterally adjacent to the given probed region), are additionally taken into account in determining the density distribution of a target material within the given probed region. Accordingly, in measurement operation 410, according to some embodiments, the density of the N_{\vec{L}} lateral locations may be dictated by the required lateral resolution(s) of the concentration map. According to some embodiments, method 400 may be based on measurement of X-rays, and, in particular, characteristic X-rays. According to some embodiments, measurement operation 410 may be implemented by applying energy-dispersive X-ray spectroscopy (EDXS) techniques or wavelength-dispersive X-ray spectroscopy (WDXS) techniques.

According to some embodiments, in the implementations of suboperation 410b an image sensor may be employed. According to some such embodiments, each pixel on the image sensor may be configured to partially or fully measure the spectrum (e.g. in an X-ray range) of the emitted light.

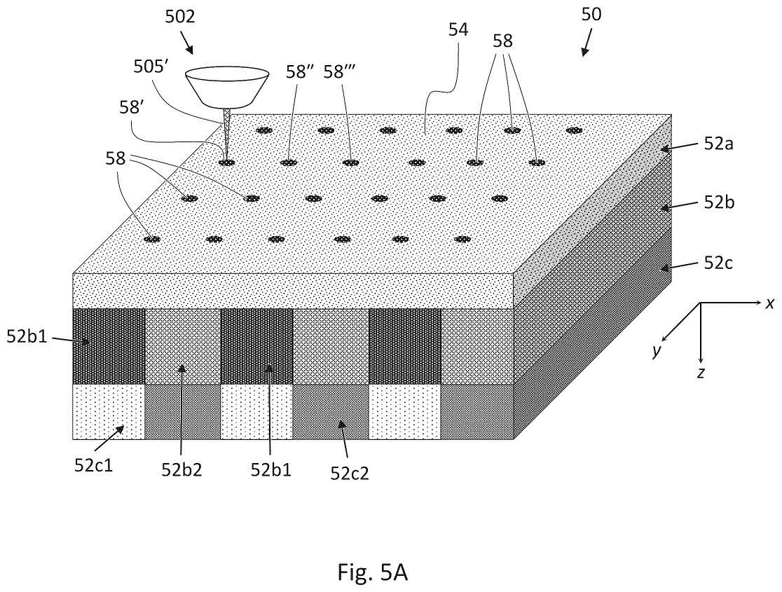

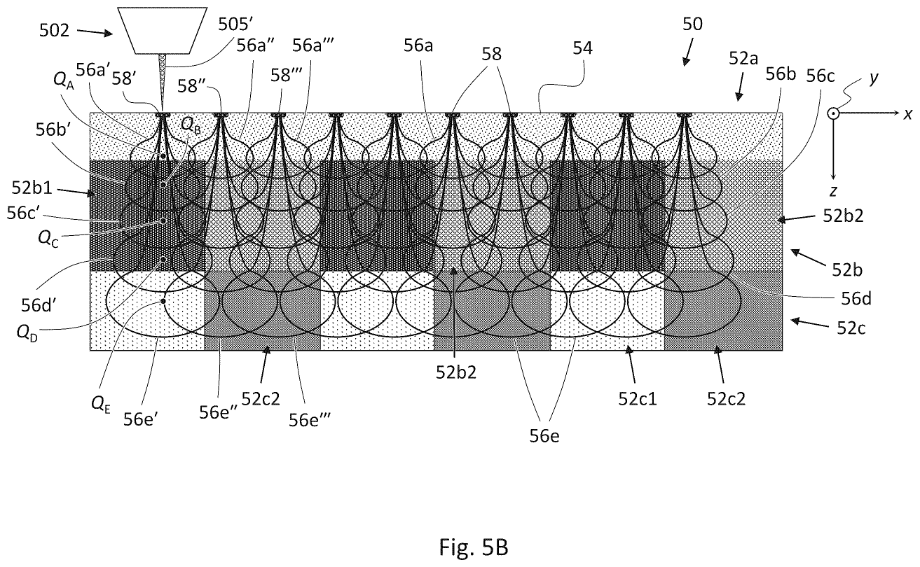

To facilitate the description, in addition to FIG. 4, reference is also made to FIGS. 5A and 5B, which schematically depict an implementation of method 400, according to some embodiments. FIG. 5A shows a perspective view of a sample 50 being probed by an e-beam in accordance with measurement operation 410. Sample 50 may include a plurality of layers 52. As a non-limiting example, it is assumed that at least some of layers 52 differ from one another in bulk material(s) and in the concentration of the target material. According to some embodiments, at least some of layers 52 may differ from one another in dimensions thereof. According to some embodiments, at least some of layers 52 may differ from one another in internal geometries thereof. According to some such embodiments, wherein layers 52 are shaped, or nominally shaped, as horizontally disposed slabs, at least some of layers 52 may differ from one another in thickness.

To facilitate the description by rendering it more concrete, it is assumed that method 400 is employed to generate a three-dimensional concentration map of a target material included in sample 50. However, the skilled person will readily grasp the generalization to other tasks, such as the two-dimensional mapping of lateral variations in the thicknesses of layers 52.

As a non-limiting example, in FIG. 5A sample 50 is shown as including three layers disposed one on top of the other: a first layer 52a, a second layer 52b, and a third layer 52c. First layer 52a is disposed above second layer 52b. Second layer 52b is sandwiched between first layer 52a and third layer 52c. The top surface of first layer 52a constitutes an external surface 54 of sample 50.

Second layer 52b is non-uniform by design and includes two types of segments: first segments 52b1 and second segments 52b2 (not all of which are numbered in FIGS. 5A and 5B). Each of first segments 52b1 and each of second segments 52b2 extends in parallel to the y-axis. First segments 52b1 and second segments 52b2 are alternately disposed. According to some embodiments, first segments 52b1 differ from second segments 52b2 in the material composition thereof, whether in terms of constituents and/or densities of same constituents. According to some embodiments, first segments 52b1 may be composed of a first semiconductor material and second segments 52b2 may be composed of a second semiconductor material. Additionally, and/or alternatively, according to some embodiments, an intended concentration of the target material in second segments 52b2 may differ from an intended concentration of the target material in first segments 52bl.

Similarly, third layer 52c is non-uniform by design and includes two types of segments: third segments 52cl and fourth segments 52c2 (not all of which are numbered in FIGS. 5A and 5B). Each of third segments 52c1 and each of fourth segments 52c2 extends in parallel to they-axis. Third segments 52cl and fourth segments 52c2 are alternately disposed. According to some embodiments, third segments 52cl differ from fourth segments 52c2 in the material composition thereof, whether in terms of constituents and/or densities of same constituents. According to some embodiments, third segments 52cl may be composed of a third semiconductor material and fourth segments 52c2 may be composed of a fourth semiconductor material. Additionally, and/or alternatively, according to some embodiments, an intended concentration of the target material in fourth segments 52c2 may differ from an intended concentration of the target material in third segments 52c1. According to some embodiments, and as depicted in FIGS. 5A and 5B, third segments 52c1 are positioned below first segments 52b1, respectively, and fourth segments 52c2 are positioned below second segments 52b2, respectively.

Also shown is an e-beam source 502. E-beam source 502 is configured to project e-beams (one at a time) on external surface 54. Also indicated are (lateral) locations 58 on external surface 54, on which the e-beams are directed. For example, in FIG. 5A, e-beam source 502 is shown generating an e-beam 505, which impinges (e.g. normally impinges) on external surface 54 at a lateral location 58′ (from lateral locations 58). At least some of the e-beams projected on the same location differ from one another in landing energy, so that sample 50 is probed (beneath lateral location 58′) at a plurality of depths. According to some embodiments, lateral locations 58 may be so distributed so as to define a lattice, for example, a square lattice.

Referring also to FIG. 5B, FIG. 5B presents a cross-sectional view of sample 50 that reveals probed regions 56 therein, according to some embodiments of method 400, and, in particular measurement operation 410. As a non-limiting example intended to facilitate the description by making it more concrete, in FIG. 5B, at each of lateral locations 58, five landing energies are shown applied. Each of probed regions 56a corresponds to a respective volume in which about all (e.g. at least 80%, at least 90%, or at least 95%) of the characteristic X-ray emitting interactions will occur due to the penetration of an e-beam at a respective first landing energy into sample 50 via a respective location from lateral locations 58. For example, a first (top) probed region 56a′ (from probed regions 56a) corresponds to the volume in which about all of the characteristic X-ray emitting interactions will occur due to the penetration of an e-beam at a first landing energy E₁′ into sample 50 via lateral location 58′.

Each of probed regions 56b corresponds to a respective volume in which about all of the characteristic X-ray emitting interactions will occur due to the penetration of an e-beam at a respective second landing energy (greater than the respective first landing energy) into sample 50 via a respective lateral location on external surface 54 from lateral locations 58. For example, a second probed region 56b′ (from probed regions 56b) corresponds to the volume in which about all of the characteristic X-ray emitting interactions will occur due to the penetration of an e-beam at a second landing energy E₂′>E₁′ into sample 50 via lateral location 58′.

Each of probed regions 56c corresponds to a respective volume in which about all of the characteristic X-ray emitting interactions will occur due to the penetration of an e-beam at a respective third landing energy (greater than the respective second landing energy) into sample 50 via a respective location from lateral locations 58. For example, a third probed region 56c′ (from probed regions 56c) corresponds to the volume in which about all of the characteristic X-ray emitting interactions will occur due to the penetration of an e-beam at a third landing energy E₃′>E₂′ into sample 50 via lateral location 58′.

Each of probed regions 56d corresponds to a respective volume in which about all of the characteristic X-ray emitting interactions will occur due to the penetration of an e-beam at a respective fourth landing energy (greater than the third landing energy) into sample 50 via a respective location from lateral locations 58. For example, a fourth probed region 56d′ (from probed regions 56d) corresponds to the volume in which about all of the characteristic X-ray emitting interactions will occur due to the penetration of an e-beam at a fourth landing energy E₄′ >E₃′ into sample 50 via lateral location 58′.

Each of probed regions 56e corresponds to a respective volume in which about all of the characteristic X-ray emitting interactions will occur due to the penetration of an e-beam at a respective fifth landing energy (greater than the fourth landing energy) into sample 50 via a respective location from lateral locations 58. For example, a fifth (bottom) probed region 56e′ (from probed regions 56e) corresponds to the volume in which about all of the characteristic X-ray emitting interactions will occur due to the penetration of an e-beam at a fifth landing energy E₅′>E₄′ into sample 50 via lateral location 58′.

First probed region 56a′ is centered about a first point Q_{A} at a depth b_{A}, second probed region 56b′ is centered about a second point Q_{B} at a depth b_{B}, third probed region 56c′ is centered about a third point Q_{C} at a depth b_{C}, fourth probed region 56d′ is centered about a fourth point Q_{D} at a depth b_{D}, and fifth probed region 56e′ is centered about a fifth point Q_{E} at a depth b_{E}. E₁′<E₂′<E₃′<E₄′<E₅′. Accordingly, b_{A}<b_{B}<b_{C}<b_{D}<b_{E}. According to some embodiments, and as depicted in FIG. 5B, fifth probed region 56e′ is of a greater size than fourth probed region 56d′, which is of a greater size than third probed region 56c′, which is of a greater size than second probed region 56b′, which is of a greater size than first probed region 56a′. Also indicated are a lateral location 58″ and a lateral location 58′ (from lateral locations 58). Each of lateral locations 58′ and 58′″ is adjacent to lateral location 58″, which is positioned there between. A (top) probed region 56a″, from probed regions 56a, corresponds to the volume in which about all of the characteristic X-ray emitting interactions will occur due to the penetration of an e-beam at a respective first landing energy into sample 50 via lateral location 58″. A (bottom) probed region 56e″, from probed regions 56e, corresponds to the volume in which about all of the characteristic X-ray emitting interactions will occur due to the penetration of an e-beam at a respective fifth landing energy into sample 50 via lateral location 58″. A (top) probed region 56a′″, from first probed regions 56a, corresponds to the volume in which about all of the characteristic X-ray emitting interactions will occur due to the penetration of an e-beam at a respective first landing energy into sample 50 via lateral location 58′″. A (bottom) probed region 56e′″, from probed regions 56e, corresponds to the volume in which about all of the characteristic X-ray emitting interactions will occur due to the penetration of an e-beam at a respective fifth landing energy into sample 50 via lateral location 58′″.

It is noted that since sample 50 is not uniform along the direction defined by the x-axis, sets of landing energies, applied at locations which differ in their x-coordinates, may differ. Thus, for example, since lateral location 58′ is positioned above one of first segments 52b1 and one of third segments 52cl while lateral location 58′ is positioned above one of second segments 52b2 and one of fourth segments 52c2, according to some embodiments, {Eᵢ′″}ᵢ₌₁⁵≠{Eᵢ′}ᵢ₌₁⁵, wherein and {Eᵢ′}ᵢ₌₁⁵ is the set of landing energies corresponding to e-beams applied via lateral location 58′ and {Eᵢ′″}ᵢ₌₁⁵ is the set of landing energies corresponding to e-beams applied via lateral location 58′″.

Example embodiments, wherein sets of landing energies may be selected to differ from one another depending on the respective lateral locations on which the e-beams are projected, include first segments 52b1 being denser than second segments 52b2, so that in order to penetrate first segments 52b1 to the same depth as second segments 52b2, a greater landing energy may be required. If, in addition, third segments 52cl are denser than fourth segments 52c2, in order to ensure that sample 50 is probed to about the same depth beneath each of lateral locations 58′ and 58′″, for each i, Eᵢ′ may be greater than Eᵢ′″. Other example embodiments, wherein sets of landing energies may be selected to differ from one another depending on the respective lateral locations on which the e-beams are projected, include first segments 52b1 and third segments 52cl being less electrically conducting than second segments 52b2 and fourth segments 52c2, respectively.

According to some embodiments, particularly embodiments wherein in data analysis operation 420 a NN is utilized to obtain the concentration map, the distances between adjacent locations from lateral locations 58 (and therefore the distances between the centers of laterally adjacent probed regions) may be selected based on the required lateral resolution (which may or may not be equal to the required vertical resolution). It is noted that while in FIG. 5B laterally adjacent probed regions are shown as overlapping, depending on the required lateral resolution, according to some other embodiments, some laterally adjacent probed regions (centered about smaller depths), or even all of the laterally probed regions, may not overlap. According to some embodiments, the lateral resolution is selected to be sufficiently high to detect and “pin-point” changes in the local concentration (density) of the target material. Accordingly, the distance between adjacent lateral locations (from lateral locations 58) may be selected to be smaller than the width of first segments 52b1 as well as the width of second segments 52b2.

Alternatively, according to some embodiments, wherein a linear model-incorporating algorithm (i.e. an algorithm constituted by a linear model or incorporating a linear model as a sub-algorithm) may be employed in data analysis operation 420 to determine the concentration map, the numbers of landing energies employed, and lateral locations over which e-beams are impinged, may be comparatively much smaller. That is, the sample may be probed to each of a small set of preselected and/or random depths and e-beams may be projected at each of a small set of preselected and/or random lateral locations. More specifically, a linear model-incorporating algorithm may be employed in embodiments wherein the density of the target material is sufficiently small such that the intensity of X-ray radiation, which is emitted due to the presence of the target material, exhibits a substantial linear dependence on the density of the target material. In particular, if the density of the target material about a point P within the inspected sample is increased by a factor α, the contribution to the intensity of the X-ray radiation, due to the target material present about the point P, will substantially increase by the factor α.

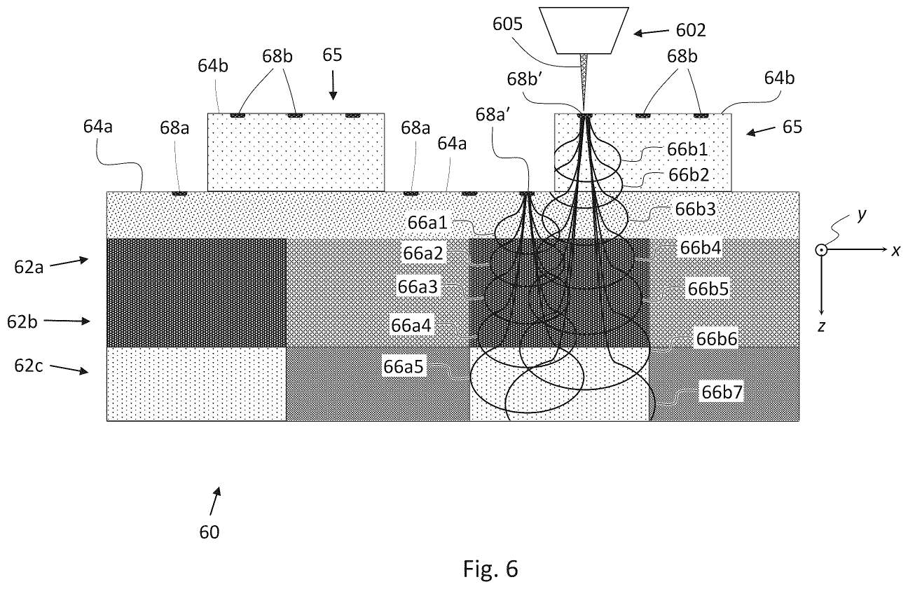

While in FIGS. 5A and 5B external surface 54 is depicted as flat, it is to be understood that method 400 may be applied to samples, which do not have a flat top surface or any extended flat surface. In particular, method 400 may be applied to samples whose top surface includes areas at different elevations with respect to a lowest disposed area(s). FIG. 6 depicts an implementation of method 400 to such a sample, a sample 60, according to some embodiments. As a non-limiting example, sample 60 is shown as including a first layer 62a, a second layer 62b, and a third layer 62c, which are disposed one on top of the other. Sample 60 further includes projecting structures 65, which are positioned on top of first layer 61 and project therefrom in the direction of the negative z-axis. Projecting structures 65 jointly have smaller lateral dimensions than first layer 62a, so that a top surface of sample 60, constituted by an external surface 64, includes two (discontinuous) lateral surfaces of different elevation: a first surface 64a and a second surface 64b. First surface 64a constitutes the top external surface of first layer 62a. Second surface 64b includes the top surfaces of projecting structures 65. According to some embodiments, projecting structures 65 may have a different composition than any of layers 62a, 62b, and 62c.

Also shown is an e-beam source 602 and an e-beam 605 produced thereby, so as to impinge (e.g. normally impinge) on external surface 64. First lateral locations 68a (not all of which are numbered) on first surface 64a indicate locations at which, in operation 410, e-beams projected by e-beam source 602 strike first surface 64a (so as to probe layers 62a, 62b, and 62c there beneath). Second lateral locations 68b on second surface 64b indicate locations at which, in operation 410, e-beams projected by e-beam source 602 strike second surface 64b (so as to probe projecting structures 65 and layers 62a, 62b, and 62c there beneath). According to some embodiments, e-beams having a first set of landing energies may be directed at each of first lateral locations 68a, respectively, and e-beams having a second set of landing energies may be directed at each of second lateral locations 68b, respectively. In order to probe sample 60 to the full depth thereof beneath both first surface 64a and second surface 64b, and to the same resolution, according to some embodiments, the second set of landing energies may generally be larger than the first set of landing energies (i.e. the number of landing energies in the second set may generally be greater than the number of landing energies in the first set).

Accordingly, depicted in FIG. 6 are (i) five probed regions 66a1, 66a2, 66a3, 66a4, and 66a5 centered below a lateral location 68a′ (from first lateral locations 68a), and (ii) seven probed regions 66b1, 66b2, 66b3, 66b4, 66b5, 66b6, and 66b7 centered below a lateral location 68b′ (from second lateral locations 68b) on a projecting structure 65′ (from projecting structure 65). Probed regions below the rest of first lateral locations 68a and second lateral locations 68b are not shown. Probed region 66b1 is confined within projecting structure 65′, while probed region 66b2 penetrates into first layer 62a but the center thereof is located in projecting structure 65′. Each of the centers of probed regions 66b3, 66b4, 66b5, 66b6, and 66b7 is located within a respective one of layers 62a, 62b, and 62c.

It is to be understood that the applicability of methods 100 and 400 is not limited to samples including nominally flat layers. Regions differing from one another in composition (whether in terms of bulk material and/or target material) may in principle be arbitrarily shaped. In particular, methods 100 and 400 may be applied to samples characterized by a continuously varying density of the target material and/or the bulk material(s) as function of the depth coordinate and/or, in the three-dimensional case, as a function of the lateral coordinates. Further, the skilled person will readily perceive that method 100 and method 400 may be applied to samples including empty cavities and/or holes.

While methods 100 and 400 have been described such that e-beams at each of a plurality of landing energies are projected on an inspected sample, according to some embodiments, wherein the set of structural parameters does not convey information regarding variation with the depth, and the required determination accuracy of the set of structural parameters is sufficiently low and/or the inspected sample is sufficiently thin, in the measurement operation (i.e. in measurement operation 110 or measurement operation 410) a single landing energy may be employed. Potentially relevant examples (in embodiments wherein the required accuracy is sufficiently low and/or the inspected sample is sufficiently thin) include the determination of the overall concentration of a target material included in an inspected sample or the generation of a two-dimensional map mapping lateral variations in the average concentration of a target material (the density of the target material averaged over the depth dimension).

### Depth-Profiling Systems

According to an aspect of some embodiments, there is provided a computerized system for depth-profiling of samples (such as patterned wafers and/or semiconductor structures e.g. included in patterned wafers). FIG. 7 presents schematically depicts such a system, a computerized system 700, according to some embodiments. As will be apparent from the description of system 700, system 700 may be used to implement methods 100 and 400. System 700 includes an e-beam source 702, a light sensor 704 (which may form part of a light sensing module), processing circuitry 706 (also referable to as “computational module”), and a controller 708. According to some embodiments, system 700 may further include a stage 720 (e.g. a xyz stage) configured to accommodate an (inspected) sample 70 (e.g. a patterned wafer). It is noted that sample 70 does not form part of system 700.

Dotted lines between elements indicate functional or communicational association there between.

An e-beam 705, generated by e-beam source 702, is shown incident on sample 70. As a result of the impinging of e-beam 705 on sample 70, and the penetration of e-beam 705 into sample 70, light rays (e.g. characteristic X-rays) are generated. A portion of these light rays, constituted by light rays 715, arrives at light sensor 704.

According to some embodiments, light sensor 704 may be configured to sense light in the X-ray frequency range. According to some such embodiments, light sensor 704 may be sensitive only to light in the X-ray frequency range. According to some embodiments, light sensor 704 may be configured to measure the numbers of photons incident thereon in each of one or more frequency ranges in the X-ray frequency range. According to some embodiments, light sensor 704 may be configured to measure the number of photons at a specific frequency (e.g. corresponding to the peak emission frequency of a target material), which are incident thereon. According to some embodiments, light sensor 704 may be configured to measure the number of photons having a first frequency (e.g. corresponding to the peak emission frequency of the target material) and the number of photons having a second frequency (e.g. corresponding to the second most intense emission frequency of the (first) target material or the peak emission frequency of a second target material), which are incident thereon. According to some embodiments, light sensor 704 may be or include an optical spectrometer, such as an energy dispersive X-ray spectrometer or a wavelength dispersive X-ray spectrometer. According to some embodiments, light sensor 704 may be or include an image sensor. According to some such embodiments, each pixel on the image sensor may be configured to measure the spectrum of the light incident thereon.

Light sensor 704 is configured to relay the data collected thereby (e.g. the spectrum (including intensities) of light incident thereon) to processing circuitry 706 either directly, or, optionally (and as depicted in FIG. 7), indirectly via controller 708.

According to some embodiments, system 700 may include additional elements. The additional elements may include electron optics (not shown; e.g. an electrostatic lens(es) and a magnetic deflector(s)), which may be used to guide and manipulate an e-beam generated by e-beam source 702. Additionally, or alternatively, the additional elements may include collection optics configured to guide onto light sensor 704 light (e.g. X-ray light) generated due to the impinging of an e-beam on sample 70 and penetration thereinto. According to some embodiments, the collection optics may include an optical filter 724 configured to block light outside the X-ray frequency range—or outside a subrange(s) of the X-ray frequency range including some or all of the expected (e.g. based on design data) characteristic X-rays—from arriving at light sensor 704.

At least e-beam source 702 and stage 720 may be housed within a vacuum chamber 730. While in FIG. 7 light sensor 704 is shown positioned inside vacuum chamber 730, according to some alternative embodiments, light sensor 704 may be positioned outside vacuum chamber 730.

Controller 708 may be functionally associated with e-beam source 702 and, optionally, stage 720. More specifically, controller 708 is configured to control and synchronize operations and functions of the above-listed modules and components during probing of an inspected sample. For example, according to some embodiments, wherein stage 720 is movable, stage 720 may be configured to mechanically translate an inspected sample (e.g. sample 70), placed thereon, along a trajectory set by controller 708.

Processing circuitry 706 includes one or more processors (i.e. processor(s) 740), and, optionally, RAM and/or non-volatile memory components; not shown). Processor(s) 740 is configured to execute software instructions stored in the non-volatile memory components. Through the execution of the software instructions, optical emission data sets (e.g. measured by light sensor 704) of an inspected sample (e.g. sample 70) are processed to determine a set of structural parameters characterizing the inspected sample, essentially as described above in the description of Depth-Profiling Methods Subsection. According to some embodiments, the set of structural parameters specifies a concentration map of a target material included in the inspected sample. According to some embodiments, at each map coordinate(s) (i.e. the vertical coordinate in the one-dimensional case, and the vertical coordinate and the two lateral coordinates in the three-dimensional case), the concentration map specifies the density of the target material to within a respective density range (from a plurality of density ranges). That is, in such embodiments, processor(s) 740 may be configured to assign the density of the target material in a subregion about the map coordinate(s) (i.e. a thin lateral layer vertically centered about the vertical coordinate in the one-dimensional case, and a subregion (i.e. voxel) centered about the map coordinates in the three-dimensional case) to a respective density range from a plurality of (complementary) density ranges. According to some alternative embodiments, at each map coordinate(s), the concentration map specifies the density in terms of a respective (single) numerical value (i.e. at each map coordinate(s) the density of the target material is assigned a numerical value from a “continuum” of densities).

Additionally, or alternatively, according to some embodiments, the set of structural parameters may include one or more of thicknesses of one or more layers of the inspected sample (in some embodiments wherein the inspected sample is layered) and/or overall concentrations (i.e. average densities) of one or more target materials included in the inspected sample.

According to some embodiments, processor(s) 740 may be configured to execute a trained algorithm, which is configured to (i) receive as inputs optical emission data sets (obtained by system 700) of an inspected sample, and/or key optical emission parameters derived from the optical emission data sets, and (ii) output a set of structural parameters of the inspected sample, as described above in the Depth-Profiling Methods Subsection. In the latter case, i.e. in embodiments wherein the trained algorithm is configured to receive as inputs key optical emission parameters, processor(s) 740 may be configured to preprocess the optical emission data sets to obtain therefrom the key optical emission parameters. The trained algorithm (e.g. the weights thereof) may depend on reference data indicative of the intended design of the inspected sample, at least in the sense of having been trained using the reference data and associated (i) measurement data (e.g. key optical emission parameters derived from measured optical emission data sets) of other samples of the same intended design as the inspected sample, and/or parts of samples of the same intended designs, respectively as corresponding parts in the inspected sample, and/or (ii) simulation data derived from simulating the impinging of (simulated) samples, which are of the same intended design as the inspected sample, with e-beams at each of a plurality of landing energies (e.g. as prescribed by methods 100 and 400).

The intended design may specify the nominal values, or nominal ranges, of geometrical and compositional parameters of the inspected sample. According to some such embodiments, wherein a concentration map of a target material, introduced into a bulk following the fabrication of the bulk, is to be obtained, the intended design may additionally specify the intended density distribution of the target material. According to some embodiments, each of the optical emission data sets, and/or the key optical emission parameters derived therefrom, may be labelled by the corresponding landing energy. According to some such embodiments, wherein a set of structural parameters, which includes “two-dimensional” and/or “three-dimensional” structural parameters (e.g. a three-dimensional concentration map and/or one or more two-dimensional maps specifying the thicknesses of layers in a layered sample as a function of the lateral coordinates), is to be determined, each of the optical emission data sets, and/or the key optical emission parameters derived therefrom, may be further labelled by the coordinates of the lateral location at which the e-beam impinged on the sample.

According to some embodiments, the trained algorithm may be a (trained) NN, such as a DNN (for example, a CNN or a fully connected NN). Alternatively, according to some embodiments, the trained algorithm may be a linear model-incorporating algorithm. The type of algorithm and the architecture thereof may be selected taking into account the intended design of the inspected sample, the ranges over which the structural parameters are expected to vary, and the accuracies to which the structural parameters are to be determined. In this regard it is noted that whether or not a key optical emission parameter exhibits linear dependence on a structural parameter will typically depend on the ranges over which the structural parameter varies: Unless the dependence is purely linear, the greater the range over which a structural parameter varies, the greater may be the deviation from linear dependence. For example, according to some embodiments, wherein lower accuracy suffices and the ranges over which the structural parameters are expected to vary are sufficiently small, a linear model-incorporating algorithm may be employed, while, according to some other embodiments, wherein high accuracy is required, the ranges over which the structural parameters are expected to vary are sufficiently large, and sufficiently large computational resources are available, a NN may be employed.

According to some embodiments, the trained algorithm may include a VAE and a classifier (e.g. a DNN or a SVM). The VAE may be configured to extract latent variables from the obtained optical emission data sets, optionally, after deriving therefrom key optical emission parameters. The classifier may be configured to receive as inputs the latent variables and to output the concentration map.

According to some embodiments, the NN may be a GAN.

According to some embodiments, processor(s) 740 may be configured to execute a classification NN, which is configured to generate a concentration map that at each map coordinate specifies the density to within a density range. According to some such embodiments, the NN may be a VGG NN or a ResNet.

According to some embodiments, wherein a concentration map of a target material, included in an inspected sample, is to be generated, processor(s) 740 may be configured to further take into account—in addition to the intensities of one or more characteristic X-ray lines pertaining to the target material—parameters characterizing the “background” X-ray radiation (induced by the penetration of the e-beams into the inspected sample), as described above in the Depth-Profiling Methods Subsection. According to some such embodiments, wherein processor(s) 740 is configured to generate the concentration map based on an energy signature of the target material, each component of the energy signature may correspond to an intensity of a respective characteristic X-ray line normalized by a mean background intensity about the characteristic X-ray line.

According to some embodiments, e-beam source 702 may be laterally and/or vertically translatable. According to some embodiments, e-beam source 702 may be configured to allow projecting the e-beam at any one of a plurality of incidence angles relative to sample 70. In particular, according to some such embodiments, e-beam source 702 may be configured to allow projecting the e-beam not just perpendicularly to a top surface 74 of sample 70 (i.e. at an incidence angle of 0°) but also obliquely relative thereto. In such embodiments, in obtaining the set of structural parameters, the algorithm (executable by processing circuitry 706) may be configured to take into account the incidence angles of each of the e-beams.

According to some embodiments, light sensor 704 may be laterally and/or vertically translatable, thereby allowing to control the return angle (i.e. sense X-rays returned from sample 70 at a desired return angle or a desired continuous range of return angles). According to some embodiments, X-rays induced by e-beams of different landing energies may be sensed at different return angles, respectively. In such embodiments, in obtaining the set of structural parameters, the algorithm (executable by processing circuitry 706) may be configured to take into account the return angles of each of the X-rays.

According to some embodiments, in addition to light sensor 704, system 700 may include one or more additional light sensors (not shown in FIG. 7), being thereby configured to sense X-rays returned at each of plurality of return angles, respectively.

The skilled person will readily perceive that system 700 may be used to validate nominal values of structural parameters of a sample, for example, the (nominal) concentrations of one or more target materials in a sample or the nominal thicknesses of layers of a layered sample, as described above in the description of system 100. According to some embodiments, system 700 may be used to validate a nominal density distribution of a target material included in a sample.

### Training Methods

According to an aspect of some embodiments, there is provided a method 800 for training an algorithm (e.g. a NN) for depth-profiling, and, more specifically, for implementing data analysis operation 120 of method 100 or data analysis operation 420 of method 400. The algorithm is configured to: (i) receive as inputs optical emission data sets pertaining to a sample (e.g. such as sample 70), or key optical emission parameters extracted (derived) from the optical emission data sets, and (ii) output a set of structural parameters (such as the sets of structural parameters listed above in the Depth-Profiling Methods Subsection and the Depth-Profiling Systems Subsection) characterizing an internal geometry and/or composition of the sample. Each of the optical emission data sets is obtained by projecting on the sample an e-beam at a respective landing energy from a plurality of landing energies. Method 800 may thus be employed to train an algorithm to perform data analysis operation 120 of method 100 or data analysis operation 420 of method 400. Accordingly, the algorithm may be any one of the algorithms described above in relation to methods 100 and 400. As elaborated on below, method 800 is advantageously configured to amplify a small set of pairs of ground truth (GT) data and associated measurement data (e.g. measured concentration maps of one or more materials in a small plurality of samples and corresponding measured optical emission data sets, and/or key optical emission parameters derived therefrom, each labelled by the respective landing energy) to obtain a large set of simulated training data for training the algorithm. Method 800 includes:
An operation 810, wherein simulated training data for a (trainable) algorithm (e.g. a NN) are generated by performing:
   A suboperation 810a, wherein calibration data is generated by performing for each sample from Nₛ≥1 samples (also referred to as “GT samples”):
      A suboperation 810a1 of obtaining a measured optical emission data set of the GT sample by projecting thereon (e.g. one at a time) e-beams at each of a first plurality of landing energies and measuring light (e.g. X-ray light) returned from the GT sample.
      A suboperation 810a2 of obtaining GT data characterizing the GT sample.
   A suboperation 810b, wherein the calibration data are used to calibrate a computer simulation (e.g. an estimator), which is configured to receive as inputs (actual or simulated) GT data of a sample, and (values of) landing energies of e-beams, and output corresponding simulated optical emission data sets, or simulated key optical emission parameters derived therefrom, pertaining to each of the landing energies, respectively.
   A suboperation 810c, wherein the calibrated computer simulation is used to generate simulated optical emission data sets, or simulated key optical emission parameters, corresponding to other samples (i.e. other GTs) and/or additional (e-beam) landing energies.
An operation 820, wherein the algorithm is trained using (at least) the simulated training data.

The calibration data may include the measured optical emission data sets, and/or key optical emission parameters (e.g. as specified in the Depth-Profiling Methods Subsection), and the measured GT data. More specifically, the calibration data may include measured data sets pertaining to each of the Nₛ GT samples of suboperation 810a. Each measured data set includes the measured GT data pertaining to one of the Nₛ GT samples, and the respective measured optical emission data sets (and/or key optical emission parameters derived therefrom) labelled by the landing energies of the inducing e-beams. It is noted that GT data may be richer than the set of structural parameters to be output by the algorithm (which is to be trained). For example, according to some embodiments, wherein the algorithm is configured to output the thicknesses of layers of different compositions, the GT data may specify not only thicknesses of layers in each of the GT samples but also overall concentrations of one or more materials included in each of the layers, respectively. Most generally, the GT data may specify concentration maps of one or more materials, respectively, included in each of the GT samples, and/or any information, which may be obtained using profiling techniques, and, in particular, destructive profiling techniques (such as applying scanning electron microscopy and/or a transmission electron microscopy to lamellas extracted from the GT samples and/or slices shaved there off), which may serve to improve the calibration of the computer simulation. In particular, in embodiments wherein the algorithm to undergo training is configured to output a concentration map of a target material included in a sample, in suboperation 810a2 a concentration map of the target material is obtained. However, according to some embodiments, wherein the algorithm to undergo training is configured to output comparatively less detailed information than specified by a concentration map (e.g. the overall concentration of a material included in a sample), the GT data may be less detailed.

According to some embodiments, the GT samples include samples of the same intended design as the samples which the algorithm is trained by method 800 to depth-profile. Additionally, or alternatively, according to some embodiments, at least some of the GT samples may be especially prepared so as to reflect the range of variation of a structural parameter, from a selected minimum value of the structural parameter to a selected maximum value thereof.

The simulated training data may include the simulated optical emission data sets, or simulated key optical emission parameters, and associated sets of structural parameters. Each of the associated sets of structural parameters may be constituted by or derived from GT data pertaining to a respective sample. More specifically, the simulated training data may include data sets respectively pertaining to each of a plurality of samples. Each data set includes, as an output set, a set of structural parameters pertaining to one of the samples in the plurality of samples, and, as an input set, the respective simulated optical emission data sets, and/or simulated key optical emission parameters, labelled by the landing energies of the inducing e-beams. Each sample in the plurality of samples may or may not pertain to an actual sample (e.g. one of the Nₛ GT samples profiled in suboperation 810a). An example of the former case is when the calibrated simulation is used to simulate the striking of e-beams on one or more (simulated) samples, which are characterized by the actual GT data measured in suboperation 810a2, with the (simulated) e-beams having different landing energies than those of the e-beams applied in suboperation 810a1. (That is, none of the landing energies of the simulated e-beams are included in the first plurality of landing energies of suboperation 810a1). An example of the latter case is when the calibrated simulation is used to simulate the striking of e-beams on one or more (simulated) samples characterized by GT data, which differs from the actual GT data measured in suboperation 810a2.

According to some embodiments, wherein (i) the algorithm is configured to receive as inputs key optical emission parameters and (ii) the computer simulation is configured to output (simulated) key optical emission parameters, suboperation 810b may include an initial suboperation wherein (measured) key optical emission parameters are derived from the measured optical emission data sets obtained in suboperation 810a1.

According to some embodiments, a ratio of the number of the simulated optical emission data sets to the number of the measured optical emission data sets is between about 100 and about 1,000.

According to some embodiments, the training set may include, in addition to the simulated training data, non-simulated training data, e.g. measured input sets constituted by the (measured) key optical emission parameters (each labelled by the respective landing energy) extracted from the measured optical emission data sets obtained in the implementations of suboperation 810a1, and corresponding sets of structural parameters constituted by, or derived from, the measured GT data obtained in suboperation 810a2.

According to some embodiments, the computer simulation of suboperation 810b is tailored to a specific intended design. According to some such embodiments, the computer simulation may be configured to receive as inputs (i) GT data of a sample of the specific intended design, and (ii) the landing energies of e-beams (e.g. simulated e-beams) projected on the sample, and to output respective optical emission data sets or key optical emission parameters. According to some embodiments, particularly embodiments wherein in suboperation 810c at least some of the other samples may be of different intended designs, the computer simulation may be configured to additionally receive as an input the intended design of the sample.

According to some embodiments, the algorithm (to be trained using method 800) may be a NN. According to some embodiments, the NN may be a DNN, such as a CNN or a fully connected NN, or may include a VAE and a classifier or a multi-head, as detailed above in the descriptions of methods 100 and 400. According to some embodiments, the NN may be a GAN.

According to some embodiments, the NN may be a classification NN (in which case, in embodiments wherein the algorithm is configured generate a concentration map of a target material, at each map coordinate(s), the concentration map specifies the density of the target material to within a respective density range from a plurality of density ranges).

Suboperation 810a1 may be implemented as specified in the description of measurement operations 110 and 410 of methods 100 and 400, respectively, in the Depth-Profiling Methods Subsection above. In particular, the use of e-beams of different landing energies allows obtaining (measured) optical emission data sets pertaining to probed regions of the sample, which are centered about different depths, respectively.

Suboperation 810a2 may be implemented by profiling lamellas extracted from a sample (i.e. one of the Nₛ GT samples) and/or slices shaved off the sample. According to some embodiments, the profiling may be performed using a SEM and/or a TEM.

According to some embodiments, wherein the output of the algorithm is a three-dimensional concentration map of a target material, and the measured GT data, obtained in the Nₛ implementations of suboperation 810a2, specify, include, or are indicative of three-dimensional concentration maps of the target material in each of the Nₛ GT samples: (i) in each implementation of suboperation 810a1, the e-beams are projected on the respective GT sample at each of a plurality of lateral locations thereon, and (ii) in suboperation 810c the simulated optical emission data sets, and/or the simulated key optical emission parameters derived therefrom, are generated for each of the plurality of lateral locations. According to some such embodiments, in operation 820 each of the simulated optical emission data sets, and/or the simulated key optical emission parameters, used as inputs in training the algorithm, is further labelled by the lateral location at which the respective (simulated) e-beam impinged on the respective sample.

Similarly, according to some embodiments, wherein the algorithm is configured to output (i) one or more two-dimensional maps specifying the thicknesses of layers in a layered sample as a function of lateral coordinates (i.e. perpendicular to the depth dimension), and/or (ii) one or more two-dimensional maps specifying lateral variations in the average concentrations (wherein the average is taken over the depth dimension) of one or more target materials included in a sample: (i) in each implementation of suboperation 810a1, the e-beams are projected on the respective GT sample at each of a plurality of lateral locations thereon, and (ii) in suboperation 810c the simulated optical emission data sets, and/or the simulated key optical emission parameters, are generated for each of the plurality of lateral locations. According to some such embodiments, in operation 820 each of the simulated optical emission data sets, and/or the simulated key optical emission parameters, used as inputs in training the algorithm, is further labelled by the lateral location at which the respective (simulated) e-beam impinged on the respective sample.

According to some embodiments, the calibration of the computer simulation involves calibration of point spread functions. According to some such embodiments, a modified Richardson-Lucy algorithm may be applied to obtain calibrated PSFs from initial PSFs (thereby calibrating the computer simulation).

More specifically, according to some embodiments, initially, i.e. prior to the calibration of the computer simulation in suboperation 810b, the computer simulation specifies a set of initial point spread functions (PSFs) {H_{E, λ}⁽ⁱ⁾}_{E, λ}. (The indices on the curly brackets serve to denote that the corresponding symbols are generally running indices.) Each of the H_{E, λ}⁽ⁱ⁾ corresponds to a respective landing energy (as indicated by the subscript E) from a set of landing energies, which includes the first plurality of landing energies, and, optionally, other landing energies. The index λ denotes the wavelength of the sensed light (the PSF will typically vary with the wavelength of the sensed light). More specifically, for each pair of landing energy E and wavelength λ (and lateral location at which the e-beam impinges on the sample in the three-dimensional case), the corresponding initial PSF specifies, as a function of the depth within the sample (and lateral coordinates in the three-dimensional case), the intensity of the light having the wavelength λ, which will be (a) generated by the target material, per particle or unit mass, due to the striking of the respective e-beam (i.e. having the landing energy E), and (b) detected by the light sensor employed.

The set of initial PSFs may be obtained by a second computer simulation. The second computer simulation models the striking and penetration of an e-beam at each of the landing energies into a simulated sample and the X-ray light emitting interaction (or at least characteristic X-ray emitting interaction) of the e-beam with matter in the simulated sample. The simulated sample is of a same design as the intended design of the samples, which are to be depth-profiled using method 100 (or method 400) with the trained algorithm (tailored for the intended design) used in executing data analysis operation 120 (or data analysis operation 420). In suboperation 810b each in the set of initial PSFs {H_{E, λ}⁽ⁱ⁾}_{E, λ}, is calibrated, thereby obtaining a set of calibrated PSFs {H_{E, λ}^{(c)}}_{E, λ}. The superscripts i (for “initial”) and c (for “calibrated”) serve to distinguish between the two sets.

According to some embodiments,

$${\{ {H}_{E , λ}^{( i )} \}}_{E , λ} = {\{ {H}_{E , λ}^{( i )} \}}_{E = {E}_{min}}^{{E}_{max}} ( and {\{ {H}_{E , λ}^{( c )} \}}_{E , λ} = {\{ {H}_{E , λ}^{( c )} \}}_{E = {E}_{min}}^{{E}_{max}} ) ,$$

wherein Eₘᵢₙ is the minimum landing energy and Eₘₐₓ is the maximum landing energy. That is, the subscript λ is not a running index. According to some such embodiments, wherein the trained NN is employed in data analysis operation 120 of method 100, in each implementation of suboperation 110b (of measurement operation 110), the intensity of the emitted light is measured only at a specific frequency (e.g. the peak characteristic X-ray emission frequency of a target material). According to some other such embodiments, wherein the trained NN is employed in data analysis operation 120 of method 100, in each implementation of suboperation 110b, the intensity of the emitted light is measured at a plurality of frequencies (e.g. employing a spectrometer), but, in data analysis operation 120, the concentration map is generated based on optical emission data corresponding to a single frequency (potentially after a preprocessing operation, e.g. to reduce noise, involving optical emission data pertaining to other frequencies).

It is noted that in the one-dimensional case (e.g. when a one-dimensional concentration map of a target material in a sample is to be obtained and uniformity along lateral directions may be assumed at least over a small range of a few micrometers), each of the initial and calibrated PSFs will depend on the depth z and the (one-dimensional, e.g. particle) density ρ(z). More specifically, H_{E, λ}(ρ(z), z) gives the contribution of the target material at the coordinate z to the intensity of returned X-rays (having the wavelength λ and produced as a result of impinging the sample with an e-beam at a landing energy E). Generally, H_{E, λ}(ρ(z), z)) may be highly nonlinear in the density p over a region of an inspected sample, which is to be profiled. In such embodiments, in order to derive H_{E, λ}^{(c)}(ρ(z), z), H_{E, λ}⁽ⁱ⁾(ρ(z), z) is “piecewise linearized” in the sense of being approximated as a sum of linear functions of the density p having support over distinct and complimentary intervals of z.

More precisely, the sample (or a part thereof which is to be profiled) may be “broken up” into segments over each of which H_{E, λ}⁽ⁱ⁾(ρ(z), z) substantially exhibits linearity. It is noted that generally the segments may differ in thickness. Further, the thicknesses of the segments may vary depending on the landing energy E (and the wavelength λ). For the sake of simplicity, in the following it is assumed that for each landing energy the sample is broken up into K segments Δzₖ=(zₖ₋₁, zₖ) with zₖ₋₁<zₖ, 1≤k≤K, z₀=0, and z_{K}=zₘₐₓ. Accordingly, and assuming that the concentration of the target material is sufficiently small, for each k, over the k-th interval H_{E, λ}(ρ(z), z)→H_{E, λ, k}(z)·ρ(z). For each k, the respective PSF—that is, H_{E, λ, k}(z)—is non-vanishing only over the k-th interval (i.e. H_{E, λ, k}(z)=0 for z<zₖ₋₁ and z>zₖ). Accordingly, for each landing energy E of the e-beam (and wavelength λ of the measured X-ray line) K initial PSFs (i.e. the set

$${\{ {H}_{E , λ , k}^{( i )} ( z ) \}}_{k = 1}^{K} )$$

are calibrated. More generally, when the concentration of the target material is larger, for each k, over the k-th interval, H_{E, λ}(ρ(z), z)→H_{E, λ, k}⁽⁰⁾(z)+H_{E, λ, k}⁽¹⁾(z)·Δρₖ(z). Here Δρₖ(z) quantifies spatial fluctuations about a baseline concentration in the k-th interval Δzₖ.

As a non-limiting example, assuming that the measured intensities (i.e. the measured numbers of photons) are Gaussian-distributed, in the linear regime, the probability of measuring an intensity I_{E, λ}, given the actual (i.e. true to the required accuracy) H_{E, λ, k}(z), is given by: p (I_{E, λ}|{H_{E, λ, k}(z)}ₖ₌₁^{K}, ρ(z))∝exp [− [symbol] (I_{E, λ}−∫₀^{z}^{ₘₐₓ}dz ρ(z)·Σₖ H_{E, λ, k}(z))²]. [symbol] is a normalization factor. Since in this example, the calibration is performed separately with respect to each wavelength (or, equivalently, frequency), in the following the subscript λ is dropped.

For a sufficiently large number of photons sensed,

$${\{ {H}_{E , k}^{( i )} ( z ) \}}_{k = 1}^{K}$$

is expected to maximize the likelihoods

$$p ( I {,}_{E , s} \vert {\{ {H}_{E , k}^{( i )} ( z ) \}}_{k = 1}^{K} , {ρ}_{s} ( z ) ) .$$

The added subscripts denotes the GT sample (from the Nₛ GT samples of suboperation 810a). The I_{E, s} are the intensities, measured in the Nₛ implementations of suboperation 810a1, and the ρₛ(z) are densities of the target material in each of the Nₛ GT samples, respectively. Discretizing the H_{E, k}(z), so that for each k H_{E, k}(z) is approximated by the average thereof over Δzₖ H_{E, k}= [symbol] H_{E, k}(z) [symbol] _{Δz}_{ₖ}, the H_{E, k}^{(c)}(z) (or, more precisely, the discretization thereof Ĥ_{c}) may be deduced by solving the optimization problem (Eq. 1): Ĥ_{c}=argmin_{Ĥ}(∥Ĥ\hat{ρ}−Î∥_{F}²+γ∥Ĥ−Ĥᵢ∥_{F}²). Here Ĥ is a N_{E}×K matrix, wherein N_{E} is the number of landing energies. That is, the rows of Ĥ are constituted by the \vec{H}_{E}, wherein, for each landing energy E, \vec{H}_{E}=(H_{E, 1}, H_{E, 2}, . . . , H_{E, K}) (H_{E, k}= [symbol] H_{E, k}(z) [symbol] _{Δz}_{ₖ}). The hat symbol is used herein to indicate matrices. \hat{ρ} is a K×Nₛ matrix, so that Ĥ\hat{ρ} is a N_{E}×Nₛ matrix. For each 1≤j≤Nₛ, the j-th column of \hat{ρ} specifies averaged values of the density of the target material in the j-th GT sample about each of the K depths, i.e. for each j and k, the (j, k)-th component of \hat{ρ} equals [symbol] ρⱼ(z) [symbol] _{Δz}_{ₖ} (ρⱼ(z) being the density of the target material in the j-th GT sample). Î is a N_{E}×Nₛ matrix. For each 1≤j≤Nₛ, the j-th column of Î specifies the intensities (i.e. the measured number of photons) for each of the plurality of landing energies measured in the implementations of suboperation 810a1 (for the given wavelength with respect to which the corresponding PSFs are calibrated) when applied with respect to the j-th GT sample. The rows of Ĥᵢ are constituted by the (row) vectors [symbol] , which are obtained by discretizing the H_{E, k}⁽ⁱ⁾(z). (For each landing energy E, [symbol] =(H_{E, 1}⁽ⁱ⁾, H_{E, 2}⁽ⁱ⁾, . . . , H_{E, K}⁽ⁱ⁾), wherein for each k H_{E, k}⁽ⁱ⁾= [symbol] H_{E, k}⁽ⁱ⁾(z) [symbol] _{Δz}_{ₖ}.) The subscript F indicates the Frobenius norm. γ is a hyperparameter whose value may be “manually” adjusted to optimize, or at least improve, the estimate of Ĥ (and thereby of the H_{E}(z)). Similarly, the degree of discretization (i.e. the magnitude of K) may be selected based on the required accuracy. The optimization problem may be solved iteratively, e.g. using a modified Richardson-Lucy algorithm, wherein, as a first approximation Ĥ is taken to equal Ĥᵢ. According to some embodiments, N_{E}≥K.

It is noted that the above optimization problem is underdetermined, and so has no unique solution. There is thus no absolute guarantee that the deduced H_{E}^{(c)}(z) will closely match the actual H_{E}(z). Nevertheless, if the initially simulated PSFs (i.e. the H_{E}⁽ⁱ⁾(z)) are sufficiently close to the actual H_{E}(z), the solution of the optimization problem will likely closely match the actual H_{E}(z).

In the three-dimensional case (e.g. when a three-dimensional concentration map of a target material in a sample is to be obtained), the optimization problem (Eq. 1) may be solved with Ĥ, \hat{ρ}, and Î generalized to three-dimensions. More specifically, each of the PSFs is a three-variable function and is further indexed by the coordinates \vec{L}=(Lₓ, L_{y}) of the lateral location on which the respective e-beam struck (i.e. impinged on) the sample. Accordingly, in such embodiments, in suboperation 810c:

$${\{ {H}_{E , \vec{L} , λ}^{( i )} ( ρ ( \vec{r} ) , \vec{r} ) \}}_{E , \vec{L} , λ} \to {\{ {H}_{E , \vec{L} , λ}^{( c )} ( ρ ( \vec{r} ) , \vec{r} ) \}}_{E , \vec{L} , λ} ,$$

wherein \vec{r}=(x, y, z) and ρ(\vec{r}) denotes the density of the target material as a function of \vec{r}.

According to some embodiments, in order to derive the H_{E, \vec{L}, λ}^{(c)}(ρ(\vec{r}), \vec{r}), the sample, or a part thereof which is to be depth-profiled, may be “broken up” into small volumes over each of which H_{E, \vec{L}, λ}⁽ⁱ⁾(ρ(\vec{r}), \vec{r}) exhibits substantial linearity. For the sake of simplicity, in the following it is assumed that for each (e-beam) landing energy E and e-beam striking location \vec{L} the profiled region is broken up into K=Kₓ×K_{y}×K_{z} volumes ΔV_{\vec{k}}. For each \vec{k}=(kₓ, k_{y}, k_{z}), the volume ΔV_{\vec{k}} is defined by intervals Δxₖ_{ₓ}=(xₖ_{ₓ}₋₁, xₖ_{ₓ}) in x, Δyₖ_{_{y}}=(yₖ_{_{y}}₋₁, yₖ_{_{y}}) in y, and Δzₖ_{_{z}}=(zₖ_{_{z}}₋₁, zₖ_{_{z}}) in z, wherein 1≤kₓ≤Kₓ, 1≤k_{y}≤K_{y}, and 1≤k_{z}≤K_{z}. Accordingly, for each landing energy E (and wavelength λ of the measured X-ray line) and e-beam striking location \vec{L}, K initial PSFs (i.e. the set

$${\{ {H}_{E , \vec{L} , λ , \vec{k}}^{( i )} ( z ) \}}_{\vec{k}} )$$

are calibrated.

Dropping the subscript λ (if more than a single wavelength is measured, the calibration is performed separately with respect to each wavelength), for each E and \vec{L}, the H_{E, \vec{L}, \vec{k}}, (\vec{r}) may be approximated by a K component (row) vector \vec{H}_{E, \vec{L}}, with K components

$${H}_{E , \vec{L} , \vec{k}} = {〈 {H}_{E , \vec{L} , \vec{k}} ( \vec{r} ) 〉}_{Δ {V}_{\vec{k}}} . {〈 {H}_{E , \vec{L} , \vec{k}} ( \vec{r} ) 〉}_{Δ {V}_{\vec{k}}}$$

is the average of H_{E, \vec{L}, \vec{k}}(\vec{r}) taken over the volume ΔV_{\vec{k}} defined by kₓ-th interval in x, the k_{y}-th interval in y, and the k_{z}-th interval in z. The rows of Ĥ are constituted by the \vec{H}_{E, \vec{L}}. Accordingly, Ĥ is a (N_{E}·N_{\vec{L}})×K matrix, wherein N_{\vec{L}} is the number of e-beam striking locations on the sample. \hat{ρ} is now a K×Nₛ matrix (of averaged values of the densities ρₛ(\vec{r}) in each of the volumes ΔV_{\vec{k}}), so that Ĥ\hat{ρ} is a (N_{E}·N_{\vec{L}})×Nₛ matrix. Î is a (N_{E}·N_{\vec{L}})×Nₛ matrix. For each 1≤j≤Nₛ, the j-th column of Î specifies the number of photons—per each of the N_{\vec{L}} impinged locations and each of the plurality of landing energies—detected in suboperation 810a when profiling the j-th GT sample. According to some embodiments, N_{E}·N_{\vec{L}}≥K.

According to some embodiments, in suboperation 810c, the other samples are of different intended designs than the Nₛ GT samples of suboperation 810a.

According to some embodiments, suboperations 810b and 810c and operation 820 may be reapplied when relevant new calibration data become available. More specifically, even after the algorithm has been trained (and can be used to implement data analysis operation 120 of method 100), as new calibration data—particularly, pertaining to other intended designs (e.g. new internal geometries, bulk materials, and/or target material density distributions, and, optionally, even other target materials)—become available, suboperations 810b and 810c and operation 820 may be reapplied to expand the applicability of method 100 and/or improve the accuracy thereof.

According to some embodiments, wherein, in suboperation 810c, the simulated key optical emission parameters are generated for, or also for, other samples (i.e. characterized by other GTs differing from the GTs of the GT samples of operation 810a), in operation 820, each of the simulated key optical emission parameters, used as inputs in training the algorithm, is further labelled by the sample with respect to which the simulated key optical emission parameters were obtained.

According to some embodiments, operation 820 includes an initial training suboperation, which may be unsupervised, in which latent variables, characterizing the simulated optical emission data, are extracted.

According to some alternative embodiments, Hi may be calibrated using a U-Net deep learning NN. That is, Ĥ_{c}=U_{F} (θ)∘Ĥᵢ, wherein U_{F}(θ)—the U-Net—is a CNN and the symbol ∘ denotes the application of U_{F}(θ) on Ĥᵢ. θ denotes a set of adjustable parameters of the U-Net. U_{F}(θ) is obtained from constraints imposed the measured GT data and associated measured optical emission data sets, which can be compactly expressed as Î=(U_{F}(θ)∘Ĥᵢ) \hat{ρ}. It is noted that since U_{F}(θ) is nonlinear, unlike the above-described maximum-likelihood based calibration approach, the H_{E, λ}⁽ⁱ⁾(ρ(z), z)—from which Ĥᵢ is obtained through discretization—need not be broken up into segments over which linear behavior is exhibited.

The skilled person will readily perceive that method 800 may be used train an algorithm (e.g. a NN) to perform operation 120 of method 100 in embodiments wherein method 100 is used to validate the (nominal) concentration map of a material in a sample, as explained above in the description of method 100.

As used herein, the terms “concentration map” and “density distribution” are interchangeable. Further, the terms “X-rays”, “X-ray light”, and “X-ray radiation” may be used interchangeably.

As used herein, the terms “measuring” and “sensing” are used interchangeably.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

According to some embodiments, an estimated quantity or estimated parameter may be said to be “about optimized” or “about optimal” when falling within 5%, 10%, or even 20% of the optimal value thereof. Each possibility corresponds to separate embodiments. In particular, the expressions “about optimized” and “about optimal” also cover the case wherein the estimated quantity or estimated parameter is equal to the optimal value of the quantity or the parameter. The optimal value may in principle be obtainable using mathematical optimization software. Thus, for example, an estimated (e.g. an estimated residual) may be said to be “about minimized” or “about minimal/minimum”, when the value thereof is no greater than 101%, 105%, 110%, or 120% (or some other pre-defined threshold percentage) of the optimal value of the quantity. Each possibility corresponds to separate embodiments.

For ease of description, in some of the figures a three-dimensional cartesian coordinate system (with orthogonal axes x, y, and z) is introduced. It is noted that the orientation of the coordinate system relative to a depicted object may vary from one figure to another. Further, the symbol ⊙ may be used to represent an axis pointing “out of the page”, while the symbol ⊗ may be used to represent an axis pointing “into the page”.

In block diagrams dotted lines connecting elements may be used to represent functional association or at least one-way or two-way communicational association between the connected elements.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although operations of methods, according to some embodiments, may be described in a specific sequence, the methods of the disclosure may include some or all of the described operations carried out in a different order. In particular, it is to be understood that the order of operations and suboperations of any of the described methods may be reordered unless the context clearly dictates otherwise, for example, when a latter operation requires as input the output of earlier operation or when a latter operation requires the product of an earlier operation. A method of the disclosure may include a few of the operations described or all of the operations described. No particular operation in a disclosed method is to be considered an essential operation of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purposes and should not be regarded as limiting. Citation or identification of any reference in this application shall not be construed as an admission that such reference is available as prior art to the disclosure. Section headings are used herein to ease understanding of the specification and should not be construed as necessarily limiting.

What is claimed is:

1. A system for non-destructive depth-profiling of samples, the system comprising:
an electron beam (e-beam) source configured to project e-beams on an inspected sample at each of a plurality of landing energies, which induce X-ray emitting interactions within each of a plurality of probed regions, respectively, in the inspected sample, whose depth is determined by the landing energy;
a light sensor configured to measure the emitted X-ray light to obtain optical emission data sets pertaining to each of the probed regions, respectively; and
processing circuitry configured to determine a set of structural parameters, which characterizes an internal geometry and/or a composition of the inspected sample, based on the measured optical emission data sets and taking into account reference data indicative of an intended design of the inspected sample.

2. The system of claim 1, wherein the reference data comprise design data of the inspected sample and/or ground truth (GT) data of other samples of the same intended design as the inspected sample and/or GT data of especially prepared samples exhibiting selected variations with respect to the intended design.

3. The system of claim 1, wherein the set of structural parameters specifies a concentration map quantifying a dependence of a concentration of a target material, which the inspected sample comprises, at least on the depth.

4. The system of claim 3, wherein the inspected sample comprises a bulk into which the target material has been introduced, and wherein the bulk is or comprises a semiconductor structure; and/or
wherein the target material comprises fluorine, nitrogen, boron, and/or gallium.

5. The system of claim 1, wherein the set of structural parameters comprises one or more of:
one or more overall concentrations of one or more materials, respectively, that the inspected sample comprises; and
at least one width of at least one structure, respectively, which is embedded in the inspected sample; and
when the inspected sample comprises a plurality of layers:
at least one thickness of at least one of the plurality of layers, respectively;
a combined thickness of at least some of the plurality of layers; and
at least one mass density of at least one of the plurality of layers, respectively.

6. The system of claim 1, wherein the light sensor is configured to measure an intensity of at least a portion of the respectively emitted X-ray light, which has a frequency equal to, or within a frequency range about, a peak characteristic X-ray emission frequency of a target material, which the inspected sample comprises.

7. The system of claim 6, wherein the light sensor comprises an energy-dispersive X-ray spectrometer or a wavelength-dispersive X-ray spectrometer.

8. The system of claim 3, further configured to allow projecting the e-beams so as to impinge on the inspected sample at each of controllably selectable lateral locations thereon; and
wherein the concentration map is three-dimensional.

9. The system of claim 1, wherein, in order to determine the set of structural parameters, the processing circuitry is configured to execute a trained algorithm, which is configured to receive as inputs key optical emission parameters extracted from the optical emission data sets.

10. The system of claim 9, wherein weights of the trained algorithm are determined through training using the reference data and (i) key optical emissions parameters, which are derived from optical emission data sets of other samples of the same intended design as the inspected sample, and/or (ii) simulation data, which are derived from simulating impinging of samples of the same intended design as the inspected sample with e-beams at each of a plurality of landing energies.

11. The system of claim 9, wherein the trained algorithm is or comprises a neural network, or wherein the trained algorithm is or comprises a linear model-incorporating algorithm.

12. The system of claim 11, wherein the set of structural parameters specifies a concentration map quantifying a dependence of a concentration of a target material, which the inspected sample comprises, at least on the depth; and
wherein the neural network is a classification neural network and at each map coordinate the concentration map specifies the density of the target material to a respective density range from a plurality of density ranges.

13. A computer-based method for non-destructive depth-profiling of samples, the method comprising:
a measurement operation comprising, for each of a plurality of landing energies, selected so as to allow probing an inspected sample to a plurality of depths, suboperations of:
projecting an electron beam (e-beam) on the inspected sample, which induces X-ray light-emitting interactions within a respective probed region of the inspected sample, whose depth is determined by the landing energy; and
measuring the emitted X-ray light to obtain an optical emission data set pertaining to the probed region; and
a data analysis operation comprising determining a set of structural parameters, which characterizes an internal geometry and/or a composition of the inspected sample, based on the measured optical emission data sets and taking into account reference data indicative of an intended design of the inspected sample.

14. A method for training a neural network (NN) for use in non-destructive depth-profiling of samples, the method comprising operations of:
generating simulated training data for a NN, which is configured to (i) receive as inputs, optical emission data sets of a sample, and/or key optical emission parameters thereof, each pertaining to a respective landing energy from a plurality of landing energies of a respectively inducing electron beam (e-beam), and (ii) output a set of structural parameters characterizing an internal geometry and/or a composition of the sample, by suboperations of:
for each of a plurality of ground truth (GT) samples, generating calibration data by:
obtaining measured optical emission data sets of the GT sample by projecting thereon e-beams at each of a first plurality of landing energies and measuring X-ray light returned from the GT sample; and
obtaining GT data characterizing the GT sample;
using the calibration data to calibrate a computer simulation, which is configured to receive as inputs GT data characterizing a sample and landing energies, and output corresponding simulated optical emission data sets and/or simulated key optical emission parameters; and
using the calibrated computer simulation to generate additional simulated optical emission data sets, and/or simulated key optical emission parameters, corresponding to other GTs and/or additional landing energies; and
training the NN using at least the simulated training data.

15. The method of claim 14, wherein the measured GT data specify concentration maps of one or more materials, which each of the GT samples nominally comprises.

16. The method of claim 15, wherein the set of structural parameters specifies a concentration map of a target material from the one or more materials.

17. The method of claim 14, wherein the computer simulation is calibrated such that for each pair of (i) measured GT data obtained in the suboperation of generating the calibration data, and (ii) a landing energy utilized in the suboperation of generating the calibration data, which is input into the computer simulation, simulated key optical emission parameters, which are output by the computer simulation, agree to within a required precision with the key optical emission parameters extracted from the respective measured optical emission data set.

18. The method of claim 14, wherein, prior to the calibration thereof, the computer simulation specifies initial point spread functions (PSFs) at least for each of the first plurality of landing energies;
wherein each of the initial PSFs is piecewise linearized as a function of a density of a target material, which the GT samples nominally comprise; and
wherein, in the suboperation of calibrating the computer simulation, the initial PSFs are calibrated, thereby obtaining calibrated PSFs.

19. The method of claim 18, wherein a modified Richardson-Lucy algorithm is applied to obtain the calibrated PSFs from the initial PSFs.

20. The method of claim 16, wherein the NN is a classification NN, and, at each map coordinate, a density of the target material is specified to within a respective density range from a plurality of density ranges.
